(19) United States
(12) Patent Application Publication
(10) Pub. No.: US 2021/0256545 A1
(43) Pub. Date: Aug. 19, 2021

(54) SUMMARIZING AND PRESENTING RECOMMENDATIONS OF IMPACT FACTORS FROM UNSTRUCTURED SURVEY RESPONSE DATA

(71) Applicant: Qualtrics, LLC, Provo, UT (US)

(72) Inventors: Ian McLaughlin, Seattle, WA (US); Xiaotong Duan, Seattle, WA (US); Gregory Laughlin, Seattle, WA (US); Rowan Christmas, Seattle, WA (US)

(21) Appl. No.: 16/791,849

(22) Filed: Feb. 14, 2020

(51) Int. Cl. G06Q 30/02; G06F 16/9038; G06N 20/00; G06F 40/289

(52) U.S. Cl. CPC G06Q 30/0203; G06F 40/289; G06N 20/00; G06F 16/9038

(57) ABSTRACT

This disclosure relates to methods, non-transitory computer readable media, and systems suggest an impact factor affecting an entity's target as a focus area by identifying indicators of impact factors from unstructured responses to an electronic survey and ranking such impact factors. For example, the disclosed systems identify impact factors from unstructured responses to an electronic survey question and generate impact-factor scores representing relationships between the impact factors and a target for an entity. The disclosed systems can determine impact-factor rankings based on the impact-factor scores and a relative-performance of the entity for the impact factors. By ranking the impact factors, the disclosed systems can provide suggested impact factors to the entity to assist the entity in improving entity performance related to the target.

### BACKGROUND

Electronic survey systems often apply analytical algorithms to survey responses from employees, customers, or other respondents to provide feedback in user interfaces to entities. Such feedback often relates to goals that the entities desire to achieve. Based on analytic results presented in user interfaces, the entities can use the feedback to improve employer practices, products, or services. For instance, electronic survey systems commonly distribute electronic surveys to employees and leaders within an organization to gauge interest or opinions on performance, job satisfaction, happiness, or other topics. Electronic survey systems can apply analytics tools to provide feedback from electronic survey responses indicating interest or opinions of respondents to improve an entity's practices, products, or services.

To provide such analytical insights, conventional survey systems often utilize structured, predictable response data to create an analytical dataset, such as set survey responses to multiple-choice questions or ranking questions. To further illustrate, some conventional survey systems provide fixed sets of survey questions to client devices, such as benchmark questions and fixed responses. The conventional systems can then provide survey analyses to the client devices of entities by analyzing the response data to the fixed questions. While such systems can display multiple-choice averages, summaries of topics according to fixed questions, and provide certain other insights to such entities based on the structured responses, conventional systems lack computational models to provide more dynamic and flexible analysis. Such conventional insights are limited due to the rigid nature of set questions. In particular, fixed sets of questions limit respondents to addressing predefined topics.

Similarly, some conventional survey systems set rules defining relationships between topics and structured responses. For instance, conventional systems often provide questions pre-categorized under a particular topic and predefined responses that allow the systems to analyze and provide insights predictably and consistently to entities. Although pre-categorized questions with structured response data is generally simple and predictable to analyze, such pre-categorized questions and structured response data limit the flexibility of the conventional systems to gaining insights. Such conventional systems lack accuracy and flexibility because the predefined responses presuppose relationships and causality between the subjects of the question and the responses.

### SUMMARY

This disclosure describes one or more embodiments of methods, non-transitory computer readable storage media, and systems that solve the foregoing problems in addition to providing other benefits. In particular, the disclosed systems suggest an impact factor affecting an entity's target as a focus area by identifying indicators of impact factors from unstructured responses to an electronic survey and ranking such impact factors. For example, in some embodiments, the disclosed systems identify impact factors from unstructured responses to an electronic survey question and generate impact-factor scores representing relationships between the impact factors and a target for an entity. The disclosed systems further determine, for the entity, impact-factor rankings based on the impact-factor scores and a relative performance of the entity for the impact factors. The disclosed systems further provide an interactive impact-factor indicator representing a suggested impact factor based on the impact-factor rankings. By ranking impact factors for an entity based on unstructured responses, the disclosed systems provide flexible, secure, and accurate interactive recommendations of impact factors to the entity.

### BRIEF DESCRIPTION OF THE DRAWINGS

The detailed description refers to the drawings briefly described below.

FIG. 1 illustrates a block diagram of a system environment in which an impact-factor-insight system can operate in accordance with one or more embodiments.

FIG. 2 illustrates an overview of the impact-factor-insight system analyzing unstructured survey response data to provide recommended actions related to relevant impact factors in accordance with one or more embodiments.

FIG. 3A illustrates the impact-factor-insight system generating impact-factor scores for a set of impact factors identified from unstructured responses in accordance with one or more embodiments.

FIG. 3B illustrates the impact-factor-insight system ranking a set of impact factors based on impact-factor scores and relative-performance scores for an entity in accordance with one or more embodiments.

FIGS. 4A-4F illustrate a computing device presenting graphical user interfaces for analyzing survey response data and presenting suggested interactive impact-factor indicators and response summaries in accordance with one or more embodiments.

FIG. 5 illustrates a block diagram of the system environment of FIG. 1 in accordance with one or more embodiments.

FIG. 6 illustrates a flowchart of a series of acts for providing interactive insights based on unstructured survey response data in accordance with one or more embodiments.

FIG. 7 illustrates a block diagram of a computing device in accordance with one or more embodiments.

FIG. 8 illustrates a network environment of a digital survey system in accordance with one or more embodiments.

### DETAILED DESCRIPTION

This disclosure describes embodiments of an impact-factor-insight system that suggests impact factors (e.g., drivers) affecting a target (e.g., an outcome) for an entity as focus areas by identifying indicators of impact factors from unstructured responses to an electronic survey and ranking such impact factors. Specifically, the impact-factor-insight system can analyze unstructured response data (e.g., freeform text responses) to determine whether the unstructured response data indicates one or more impact factors related to a target for an entity. The impact-factor-insight system can further generate impact-factor scores to determine a degree to which each impact factor exhibits a relationship with a particular target. The impact-factor-insight system can subsequently determine a relative performance of the entity with respect to each impact factor based on, for instance, impact-factor scores of other entities or benchmarks. The impact-factor-insight system can further rank the impact factors based on the entity's relative performance and provide one or more suggested impact factors to the entity for display on a client device. Such suggested impact factors allow the entity to focus on areas likely help the entity improve performance related to the target.

To illustrate, in some cases, the impact-factor-insight system may identify explicit or implicit descriptions of “supervisor friendliness,” “office privacy,” or other impact factors from freeform text responses to survey questions administered for an entity. The impact-factor-insight system subsequently determines impact-factor scores indicating a degree to which supervisor friendliness, office privacy, or other impact factors affect “employee engagement” as a target. The impact-factor score for supervisor friendliness may, for instance, indicate a greater effect on (or causal correlation with) employee engagement (as the target) than the impact-factor score for office privacy. Based on comparing the entity's impact-factor scores to those of other anonymous entities, the impact-factor-insight system may further rank impact factors for the entity and suggest an impact factor to the entity as a focus area for improvement.

As indicated above, in one or more embodiments, the impact-factor-insight system identifies indicators of impact factors of a target from unstructured responses to an electronic survey question. Such an electronic survey question can be associated with an entity requesting that respondents provide feedback related to the entity (e.g., related to employment matters, products, or services). The impact-factor-insight system can further determine that the responses from respondents include indications of one or more impact factors related to a target for the entity. For example, the responses can include words or phrases with explicit or implicit references to impact factors that affect the target.

The impact-factor-insight system can also generate a set of impact-factor scores for the impact factor(s) identified from the unstructured responses. For instance, the impact-factor-insight system can quantify a relationship between each impact factor and a target and generate a score representing the quantified relationship. The impact-factor-insight system can thus generate a set of impact-factor scores for a set of impact factors corresponding to the entity, where the impact-factor scores represent correlations between the impact factors and the entity. In some cases, the impact-factor scores represent a causal correlation indicating a degree to which each impact factor affects or contributes to an outcome associated with the target. For example, the impact-factor-insight system can generate impact-factor scores based on R-squared coefficients for the impact factors and the target. Alternatively, the impact-factor-insight system can generate impact-factor scores using relative weights analysis by assigning a weight to an impact factor when controlling for other impact factors.

In addition to generating impact-factor scores for impact factors, the impact-factor-insight system can also determine a relative performance of an entity with respect to the corresponding impact factors. For instance, in some embodiments, the impact-factor-insight system generates relative-performance scores for the entity. In certain cases, the impact-factor-insight system generates a relative-performance score for the entity quantifying a performance of the entity with regard to a particular impact factor. The relative-performance score can also represent a comparison between a performance of the entity for the impact factor relative to performances of other entities for the impact factor. The impact-factor-insight system can thus further determine how important an impact factor is to each entity for meeting the target. In one or more embodiments, the relative-performance scores also account for a degree to which each impact factor would need to change to meet a target (e.g., by comparing an impact factor having poor performance from all entities to an impact factor having good performance from all entities).

Based on such impact-factor scores, the impact-factor-insight system can rank the impact factors for a target as a basis for providing suggestions of specific impact factors to an entity. In some cases, the impact-factor-insight system can use the impact-factor scores and relative-performance scores for an entity (or benchmark-performance scores) to determine one or more impact factors relevant to the entity. For example, the generated rankings for a set of impact factors can allow the impact-factor-insight system to recommend one or more impact factors to the entity as areas for improvement.

To provide suggested impact factors to an entity, in some cases, the impact-factor-insight system summarizes and presents information associated with an impact factor by providing an interactive impact-factor indicator to a client device of the entity. The impact-factor-insight system can provide the indicator as a graphical-user-interface element within a management application that allows the entity to interact with the indicator and view additional information about the corresponding impact factor. According to one or more embodiments, the impact-factor-insight system can also provide suggested actions that the entity can perform to improve the entity's performance relative to the impact factor. Thus, in some embodiments, the impact-factor-insight system can assist the entity in selecting focus areas and implementing an action plan to reach a target or meet a specific outcome.

As suggested above, the impact-factor-insight system overcomes several technical deficiencies that hinder conventional survey systems. First, the impact-factor-insight system improves the flexibility with which electronic survey systems analyze survey response data to provide insights. While conventional electronic survey systems can analyze structured response data from fixed question sets, the resulting insights are limited to particular questions and responses predefined by the survey administrator. In contrast to conventional systems, in some embodiments, the impact-factor-insight system flexibly utilizes variable question sets or response inputs (e.g., fields) that allow respondents to provide unstructured (e.g., freeform text) responses. By identifying indications of impact factors from such unstructured responses, the impact-factor-insight system can quantify references to such impact factors in impact-factor scores and provide insights into a variety of topics that do not need to be predefined within the survey question/responses.

By accounting for expressions of impact factors from freeform responses (or other unstructured responses) to survey questions, the impact-factor-insight system can provide a more accurate recommendation of impact factors as focus areas than conventional systems. For example, by analyzing unstructured responses to survey questions that allow respondents to provide answers in their own words, the impact-factor-insight system can identify factors that affect a target with greater granularity than by analyzing responses with strict, predetermined responses. In contrast to conventional systems, the impact-factor-insight system is not limited to only responses determined by the entity and/or impact-factor-insight system. By identifying indicators of impact factors from unstructured responses rather than merely relying on previously identified questions or set response types, the impact-factor-insight system can capture a more accurate representation of how respondents feel regarding a topic of a survey question and better account for such unstructured impact-factor references in suggesting impact factors as focus areas. The impact-factor-insight system can thus more accurately identify additional impact factors or even subcategories of impact factors associated with a target for the entity.

In addition to improved flexibility and accuracy, in some embodiments, the impact-factor-insight system improves security and privacy of insight data. For example, some conventional systems provide comparisons between an entity and other entities (e.g., average or anonymous performance data of other entities). In some cases, the entities or markets are so limited, that competitors can discern the identity of another entity based on anonymous performance data. In contrast, by ranking impact factors for a target based on a relative performance of an entity with reference to other entities or benchmarks, the impact-factor-insight system can incorporate the performance or response data associated with other entities when providing suggestions to the entity. The ranking obscures or prevents the entity from seeing any of the performance or response data associated with the other entities. The impact-factor-insight system thus improves security of data management while retaining broad usefulness of the data.

In addition to increasing the flexibility and accuracy of computing devices providing insights related to survey response data, in some embodiments, the impact-factor-insight system further streamlines or simplifies a user experience with consolidated graphical user interfaces. In contrast to some conventional comment-review systems that funnel users through multiple selectable options and user interfaces for taking action based on survey response data, the impact-factor-insight system provides graphical user interfaces comprising response summaries, sorted interactive impact-factor indicators, and available actions related to the impact-factor indicators or a corresponding target. These consolidated summaries sorted impact-factor indicators, and available actions eliminate excess navigation through user interfaces.

As used herein, the terms “electronic survey” and “survey” refer to an electronic communication used to collect information. For example, the term survey can include an electronic communication in the form of a poll, questionnaire, census, or other type of sampling. To illustrate, an electronic survey can include an electronic communication that includes one or more electronic survey questions based on information requested by an entity. Further, the term survey as used herein can generally refer to a method of requesting and collecting electronic data from respondents via an electronic communication distribution channel. As used herein, the term “respondent” refers to a person or entity that participates in or responds to a survey. Also, as used herein, the term “administrator” refers to a person or entity that creates or causes the administration of a survey.

Additionally, as used herein, the term “electronic survey question,” “survey question,” or simply “question” refers to a prompt included in a survey to invoke a response from a respondent. For example, a survey question can include one of many different types of questions, including, but not limited to, perception, multiple choice, open-ended, ranking, scoring, summation, demographic, dichotomous, differential, cumulative, dropdown, matrix, net promoter score (NPS), single textbox, heat map, and any other type of prompt that can invoke a response from a respondent. A survey question can include a prompt portion as well as an available answer portion that corresponds to the survey question.

As used herein, the term “response” refers to electronic data a respondent provides with respect to an electronic survey question. The electronic data can include content and/or feedback from the respondent in response to a survey question. Depending on the question type, the response can include, but is not limited to, a selection, a text input, an indication of an answer selection, a user provided answer, and/or an attachment. Specifically, as used herein, the term “unstructured response” refers to a response that does not have a fixed, predetermined structure. For example, an unstructured response can include an open-ended, freeform text response that allows a respondent to input any number of characters (or a threshold number of characters) into a text field in response to a question. Additionally, an unstructured response can include data captured from one or more input devices that indicate a respondent sentiment, state-of-mind, or feeling in response to a stimulus (e.g., a prompt, media, event). For instance, an unstructured response can include captured video data of respondent reactions (e.g., facial expressions, body language) or captured biometric data (e.g., pulse, blood pressure, body temperature). In contrast, a structured response can include a response from, for example, a set of fixed choices (e.g., multiple choice).

As used herein, the term “target” refers to a goal, outcome, or end result associated with an entity. For instance, a target can include an outcome or an end result based on a combination of characteristics. In one or more embodiments, a target includes a score or other numeric value representing a performance of an entity related to a particular topic. Additionally, a target can include an organizational goal that an entity desires to accomplish related to employment practices, products, or services. As used herein, the term “impact factor” refers to a catalyst, condition, driver, process, or topic that contributes to an entity's performance associated with a particular target. As suggested above, a target can be associated with any number of impact factors that each contribute to a goal, outcome, or end result. Impact factors can combine to achieve results that are different than the sum of the individual contributions of the impact factors. For instance, impact factors related to achieving a target associated with satisfied employees can include, but are not limited to, management efficiency, culture, teamwork, or information flow.

As used herein, the term “entity” refers to a person, a group of people, or an organization associated with a person or group of people. For example, an entity can refer to a single individual such as, but not limited to, an owner, manager, employee, or customer. Alternatively, an entity can refer to a business, association, or other organized body of people.

Furthermore, as used herein, the term “interactive impact-factor indicator” refers to a graphical-user-interface element representing an impact factor that can be selected or otherwise interacted with by a user through a graphical user interface. For example, an interactive impact-factor indicator can include a digital card (or other selectable interface element) including a summary of information associated with a corresponding impact factor. In one or more embodiments, by receiving an indication of a user selecting an interactive impact-factor indicator, the impact-factor-insight system can provide additional information associated with the impact factor to display within a graphical user interface.

As used herein, the term “impact-factor score” refers to a quantified relationship between an impact factor and a target. For example, an impact-factor score can include a numerical value on a predetermined scale that indicates a degree or strength of relationship (e.g., causal correlation) between a particular impact factor and a particular target. Additionally, as used herein, the term “relative-performance score” refers to a quantified performance value of an entity for an impact factor relative to one or more other entities. For instance, a relative-performance score can include a numerical value on a predetermined scale that indicates an entity's performance with respect to a given impact factor associated with a target in comparison to a performance of at least one other entity with respect to the given impact factor. A relative-performance score can also indicate the entity's performance with respect to the impact factor relative to a maximum possible score (e.g., a measure of the entity's performance on a scale of possible score values).

As used herein, the term “impact-factor ranking” refers to a ranking of impact factors for an entity. For example, impact-factor rankings for a set of impact factors indicates a relative importance of each of the impact factors to an entity in connection with a target or multiple targets. The impact-factor rankings for the set of impact factors constitute a basis for the impact-factor-insight system to provide recommendations of one or more impact factors to the entity. As suggested above, the recommendations can allow the entity to determine on which impact factors the entity should focus to improve performance relative to the target.

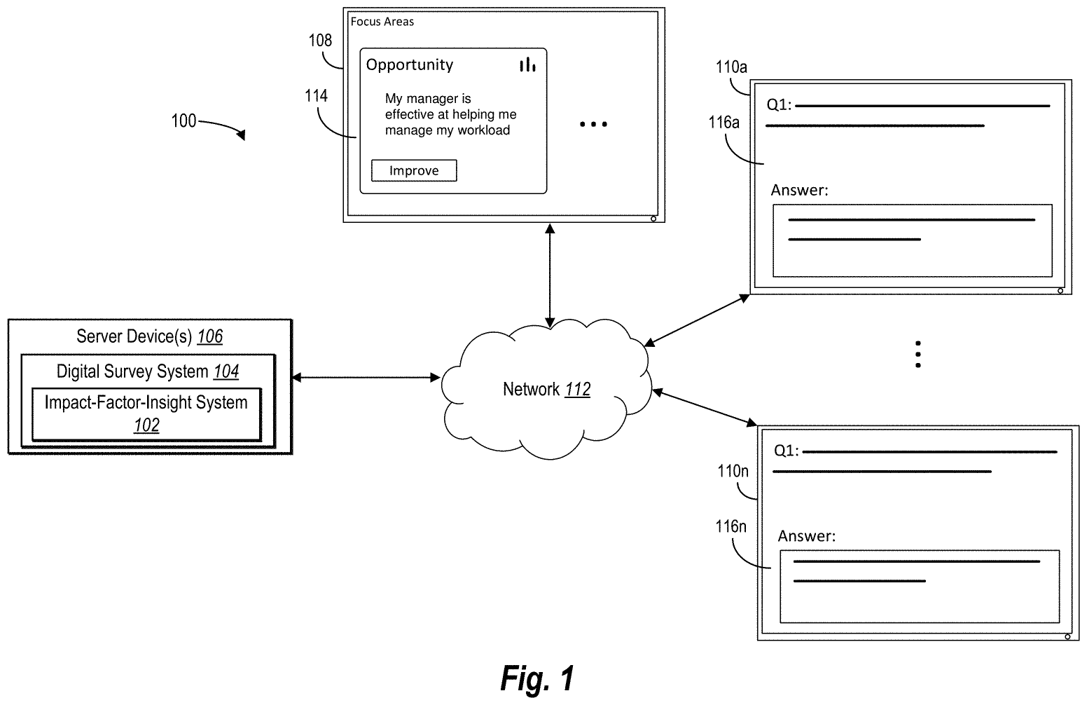

Turning now to the figures, FIG. 1 illustrates a block diagram of a system environment (“environment”) 100 in which an impact-factor-insight system 102 and a digital survey system 104 operate in accordance with one or more embodiments. As illustrated in FIG. 1, the environment 100 includes server device(s) 106, an administrator device 108, and respondent devices 110a-110n, where the server device(s) 106 include the digital survey system 104. As shown in FIG. 1, the digital survey system 104 comprises the impact-factor-insight system 102. Each of the administrator device 108 and the respondent devices 110a-110n are associated with a type of user. The administrator device 108 may be associated with an administrator that uses the administrator device 108 to manage the creation and distribution of a digital survey or review of textual responses. The respondent devices 110a-110n may be associated with respondents that use the respondent devices 110a-110n to provide textual responses (e.g., to a digital survey question).

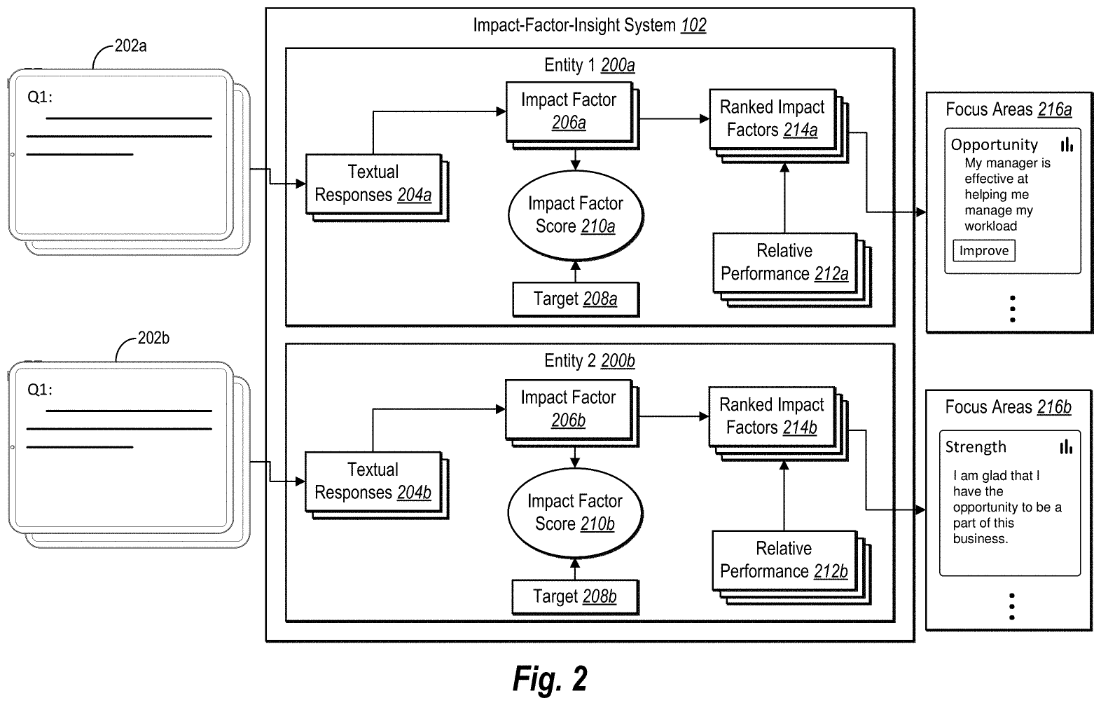

In some embodiments, the administrator device 108 and the respondent devices 110a-110n communicate with server device(s) 102 over a network 112. As described below, the server device(s) 106 can enable the various functions, features, processes, methods, and systems described herein using, for example, the impact-factor-insight system 102. As shown in FIG. 1, the impact-factor-insight system 102 comprises computer executable instructions that, when executed by a processor of the server device(s) 106, perform certain actions described below with reference to FIGS. 2-6. Additionally, or alternatively, in some embodiments, the server device(s) 106 coordinate with one or both of the administrator device 108 and the respondent devices 110a-110n to perform or provide the various functions, features, processes, methods, and systems described in more detail below. Although FIG. 1 illustrates a particular arrangement of the server device(s) 106, the administrator device 108, the respondent devices 110a-110n, and the network 112, various additional arrangements are possible. For example, the server device(s) 106 and the digital survey system 104 may directly communicate with the administrator device 108, bypassing the network 112.

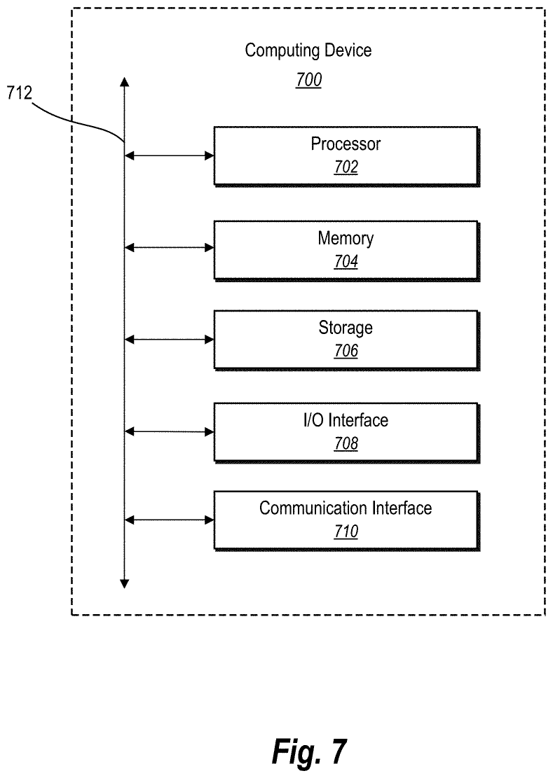

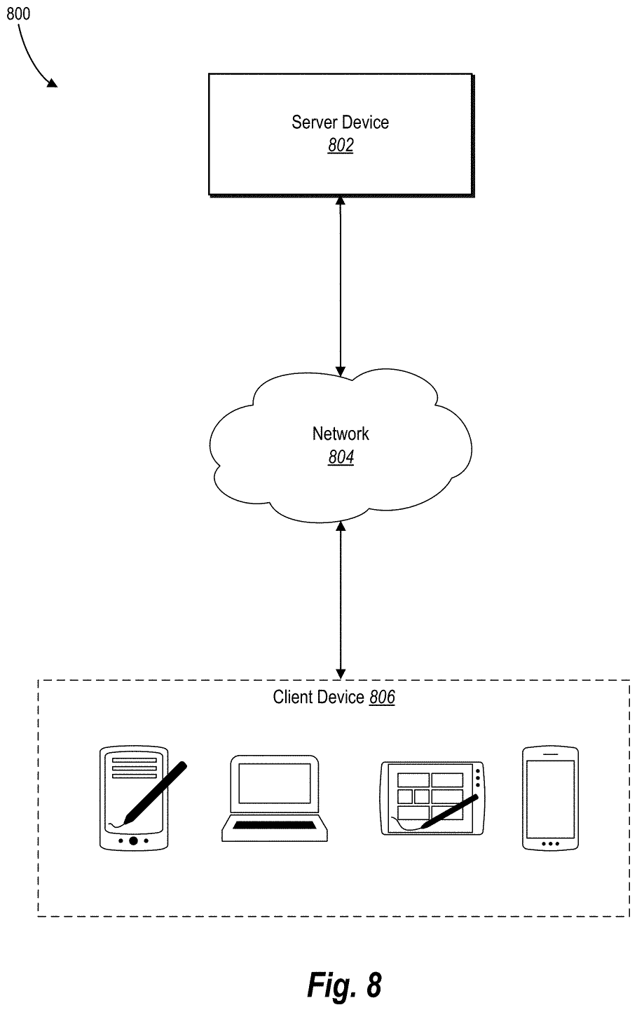

Generally, the administrator device 108 and the respondent devices 110a-110n may be any one of various types of client devices. For example, the administrator device 108 and the respondent devices 110a-110n may be mobile devices (e.g., a smart phone, tablet), laptops, desktops, or any other type of computing devices, such as those described below with reference to FIG. 7. Additionally, the server device(s) 106 may include one or more computing devices, including those explained below with reference to FIG. 7. The server device(s) 106, the administrator device 108, and the respondent devices 110a-110n may communicate using any communication platforms and technologies suitable for transporting data and/or communication signals, including the examples described below with reference to FIG. 8.

To access the functionalities of the impact-factor-insight system 102, in certain embodiments, an administrator interacts with an administrator application 114 on the administrator device 108. Similarly, to access digital surveys, compose textual responses, or other functions of the digital survey system 104, in some implementations, respondents interact with respondent applications 116a-116n, respectively. For ease of illustration, FIG. 1 depicts graphical user interfaces corresponding to the administrator application 114 and the respondent applications 116a-116n on the administrator device 108 and the respondent devices 110a-110n, respectively. In some embodiments, one or both of the administrator application 114 and the respondent applications 116a-116n comprise web browsers, applets, or other software applications (e.g., native applications or web applications) available to the administrator device 108 or the respondent devices 110a-110n, respectively. Additionally, in some instances, the digital survey system 104 provides data packets including instructions that, when executed by the administrator device 108 or the respondent devices 110a-110n, create or otherwise integrate the administrator application 114 or the respondent applications 116a-116n within an application or webpage for the administrator device 108 or the respondent devices 110a-110n, respectively. For example, in response to an open-ended question provided by the administrator device 108 (e.g., via the digital survey system 104), each respondent can use a respondent application to provide a free-form, textual response to the open-ended question. The respondent devices 110a-110n can then send the responses provided by the respondents back to the administrator device 108 (e.g., via the digital survey system 104).

As an initial overview, the server device(s) 106 provide the administrator device 108 access to the digital survey system 104 and the impact-factor-insight system 102 by way of the network 112. In one or more embodiments, by accessing the digital survey system 104, the server device(s) 106 provide one or more digital documents to the administrator device 108 to enable the administrator to compose a digital survey. For example, the digital survey system 104 can include a website (e.g., one or more webpages) or utilize the administrator application 114 to enable the administrator to create a digital survey or other digital content for distribution to the respondent devices 110a-110n.

In some cases, the administrator device 108 launches the administrator application 114 to facilitate interacting with the digital survey system 104 or its constituent impact-factor-insight system 102. The administrator application 114 may coordinate communications between the administrator device 108 and the server device(s) 106 to create an electronic survey or other digital content that the digital survey system 104 distributes to one or more of the respondent devices 110a-110n. For instance, to facilitate the creation of a digital survey, the administrator application 114 can provide graphical user interfaces of the digital survey system 104, receive indications of interactions from the administrator with the administrator device 108, and cause the administrator device 108 to communicate user input based on the detected interactions to the digital survey system 104.

As suggested above, the impact-factor-insight system 102 can analyze unstructured response data to an electronic survey question to provide recommendations or other insights to an entity regarding impact factors associated with a target. Specifically, the respondent devices 110a-110n can display an electronic survey question received from the digital survey system 104 using the respondent applications 116a-116n. Respondents can then enter responses (e.g., freeform text responses) via the respondent applications 116a-116n, and the respondent devices 110a-110n can send the responses to the digital survey system 104. In some embodiments, the impact-factor-insight system 102 can also analyze structured response data from varying sets of electronic survey questions to determine insights for the entity regarding impact factors associated with a target.

After receiving the responses from the respondent devices 110a-110n, the digital survey system 104 can utilize the impact-factor-insight system 102 to analyze the responses. The impact-factor-insight system 102 can determine the importance of each impact factor with respect to a target, as well as a relative performance of the entity, to rank the impact factors for the entity. The impact-factor-insight system 102 can then provide information associated with the impact-factor rankings to the administrator device 108 for the administrator to view via the administrator application 114. As shown in FIG. 1, for instance, the impact-factor-insight system 102 provides an interactive impact-factor indicator representing a suggested impact factor for display on the administrator device 108 based on impact-factor rankings.

As noted above, the impact-factor-insight system 102 can provide suggested impact factors related to a target for an entity based on unstructured response data. FIG. 2 provides an overview of an embodiment of the impact-factor-insight system 102 providing one or more suggested impact factors as recommendations to a plurality of entities 200a, 200b. Specifically, FIG. 2 illustrates that the impact-factor-insight system 102 identifies and ranks a set of impact factors related to a target from unstructured response data of one or more electronic survey questions for an entity. FIG. 2 further illustrates that the impact-factor-insight system 102 uses the ranked impact factors to provide one or more suggested impact factors to assist the entity in achieving the target.

As shown in FIG. 2, the impact-factor-insight system 102 can assist in administering an electronic survey. For example, in one or more embodiments, the impact-factor-insight system 102 (or the digital survey system 104 described in FIG. 1) can generate, or otherwise administer, electronic survey questions (e.g., electronic survey questions 202a, 202b) to client devices of potential respondents of an electronic survey. Specifically, the electronic survey questions 202a, 202b can include a response field or a different response method that allows respondents to enter an unstructured response, such as a text field for the obtaining of unstructured response data.

Additionally, an electronic survey question (e.g., the electronic survey question 202a) can include a request that a respondent provide feedback related to an aspect of an entity (e.g., entity 200a). In particular, the electronic survey question can include a request to provide feedback related to a performance of the entity in connection with a specific topic, such as employee management, product/service quality. For instance, the electronic survey question can include a request for an employee of a company to describe how well the company maintains a work environment or how satisfied the employee is with the company overall. Furthermore, each entity can provide a different set of electronic survey questions to respondents (e.g., entity 200b can provide the electronic survey question 202b). Although these examples provide specific topics or implementations of electronic survey questions, the electronic survey question can include any request related to some aspect of performance of an entity.

FIG. 2 also illustrates that after administering the electronic survey questions 202a, 202b, the impact-factor-insight system 102 can receive unstructured responses (e.g., textual responses 204a, 204b) to the electronic survey questions 202a, 202b. In particular, after a respondent device receives an electronic survey question associated with an entity, a respondent can enter a response to the electronic survey question. As mentioned, the response can include an unstructured response in which the respondent answers the question in his or her own words. For example, a response can include freeform text composed by a respondent describing the respondent's answer in his or her own words. The respondent device can then provide the response to the impact-factor-insight system 102.

Additionally, FIG. 2 illustrates that the impact-factor-insight system 102 analyzes the unstructured responses to identify indicators of impact factors (e.g., impact factors 206a, 206b) for an entity. Specifically, the impact-factor-insight system 102 can first determine a target (e.g., target 208a or target 208b) for the entity in connection with the electronic survey question. For example, the impact-factor-insight system 102 may determine a target (e.g., the target 208a) based on the contents or other characteristic of the electronic survey question (e.g., electronic survey question 202a). To illustrate, the impact-factor-insight system 102 can determine that the question is tagged with a target by a survey administrator. Alternatively, the impact-factor-insight system 102 can analyze the contents of the question (e.g., text) to determine the target.

Additionally, the impact-factor-insight system 102 can analyze the unstructured responses to determine impact factors associated with the target (e.g., impact factors 206a for the target 208a). In one or more embodiments, the impact-factor-insight system 102 uses machine-learning and/or other language analysis techniques to determine that an unstructured response includes words or phrases indicating an impact factor corresponding to the target. In one or more embodiments, the impact-factor-insight system 102 can utilize a Pattern Analyzer or a Natural Language Toolkit classifier by Steven Bird, Edward Loper, and Ewan Klein (2009), Natural Language Processing with Python, O'Reilly Media Inc., which is hereby incorporated for all it includes. To illustrate, the impact-factor-insight system 102 can determine whether each unstructured response explicitly or implicitly refers to an impact factor associated with the target. For example, responses can indicate an impact factor by including a key word or phrase that the impact-factor-insight system 102 has associated with an impact factor. Additionally, the impact-factor-insight system 102 can determine that responses indicate an impact factor based on context derived from the text of the responses.

According to one or more embodiments, one or more of the impact factors may be predefined impact factors defined by an administrator. In particular, an administrator may define a set of possible impact factors associated with a target before, during, or after administration of an electronic survey question. The impact-factor-insight system 102 can then determine whether any of the received responses include indications of the predefined impact factors. Alternatively, the impact-factor-insight system 102 may dynamically determine one or more impact factors associated with the target based on the responses from respondents. For instance, the impact-factor-insight system 102 may identify an impact factor if a certain number of responses reference the same topic.

FIG. 2 further illustrates that the impact-factor-insight system 102 determines relationships between impact factors and a target. In particular, after identifying impact factors for a target based on unstructured responses to an electronic survey question, the impact-factor-insight system 102 can determine how important the impact factors are to the target. More specifically, the impact-factor-insight system 102 can generate impact-factor scores (e.g., impact factor scores 210a, 210b) for the impact factors based on how closely each impact factor correlates to the target. For example, the impact-factor-insight system 102 can generate an impact factor score 210a for an impact factor of the impact factors 206a for the entity 200a indicating a degree to which the impact factor affects or relates to the target 208a. In one or more embodiments, the impact factor scores 210a, 210b are the same for a given impact factor across the entities 200a, 200b, though the impact factor scores may vary from entity to entity based on the specific impact factors, questions, and responses.

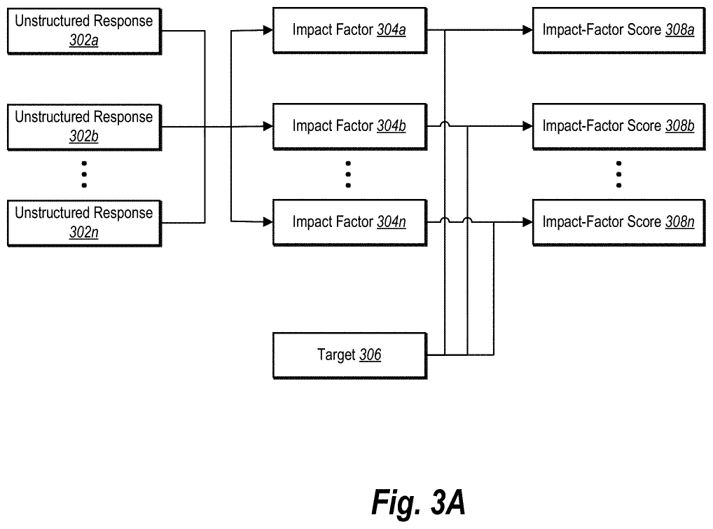

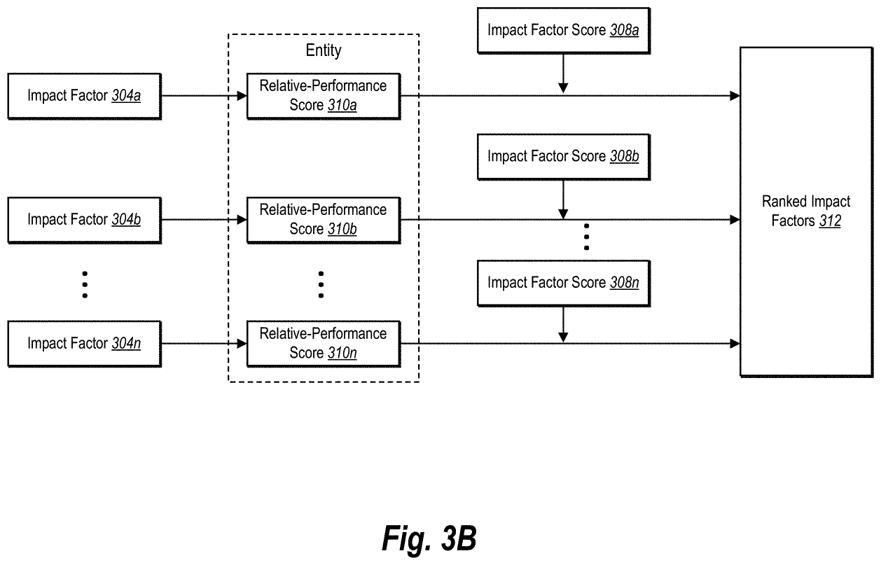

In one or more embodiments, the impact-factor-insight system 102 can generate an impact-factor score by determining a causal correlation between an impact factor and the target based on an R-squared coefficient for the impact factor and the target. Alternatively, the impact-factor-insight system 102 can generate an impact-factor score using relative weights analysis by assigning a weight to the impact factor when controlling for other impact factors. The description below with respect to FIG. 3A includes additional description of impact-factor score generation.

FIG. 2 further illustrates that the impact-factor-insight system 102 determines relative performances of each entity for the impact factors (e.g., relative performance 212a for the entity 200a and relative performance 212b for the entity 200b). In particular, the impact-factor-insight system 102 can use data provided by the entity or collected via another system indicating how well the entity performed for a particular impact factor. Additionally, the impact-factor-insight system 102 can use data provided by one or more other entities or collected via another system indicating performance of the other entities for the impact factor to determine a relative performance of the entity. To illustrate, the impact-factor-insight system 102 can determine whether the entity is near the top, average, bottom, etc., of performance for an impact factor relative to other entities. The impact-factor-insight system 102 may generate a relative-performance score providing a measurement of the relative performance.

In addition to indicating the relative performance of the entity for an impact factor, the impact-factor-insight system 102 can also generate the relative-performance score based on a difference between the entity's performance for the impact factor and a reference point (e.g., benchmark or threshold). For instance, if the entity performance for the impact factor is low on a total scale of performance values, the impact-factor-insight system 102 may include such in the relative-performance score. Even if the entity performs well relative to other entities for an impact factor, if the entity's performance with regard to the impact factor falls under a threshold or benchmark or other reference, the relative-performance score may still have a value that indicates that the impact factor is important to the entity in improvement associated with the target. Conversely, if the entity performs poorly relative to other entities, but the entity's performance with regard to the impact factor satisfies a threshold or benchmark or other reference, the relative-performance score may have a value indicating that the impact factor is not as important to the entity in improvement associated with the target. FIG. 3B and the corresponding description provide additional detail with regard to generating a relative-performance score.

FIG. 2 further illustrates the impact-factor-insight system 102 ranking the impact factors for the entity based on the impact factor relationships and relative performance of the entity. In one or more embodiments, the impact-factor-insight system 102 ranks the impact factors (e.g., generating ranked impact factors 214a, 214b from the impact factors 206a, 206b, respectively) based on how important they are relative to the target by taking into consideration the correlation between impact factors and the target (e.g., impact factor scores 210a, 210b) as well as the relative performance of the entity for each impact factor (e.g., relative performances 212a, 212b). To illustrate, impact factors that have a high correlation with the target and for which the entity performs poorly relative to other entities and/or on a performance scale can have a high rank indicating that improvement relative to these impact factors are likely to have the greatest impact relative to the target. The impact-factor-insight system 102 may rank impact factors that do not have a high correlation or for which the entity has a low relative-performance lower. FIG. 3B and the accompanying description also provide additional detail regarding ranking impact factors for an entity.

Additionally, FIG. 2 illustrates the impact-factor-insight system 102 providing interactive indicator(s) representing suggested impact factor(s) (e.g., focus areas 216a, 216b) to a device of the entity. After ranking the impact scores for the entity, the impact-factor-insight system 102 can determine one or more impact factors to provide as recommendations to the entity. The recommendation(s) can include an indication that improving performance for the corresponding impact factor(s) are most likely to improve the entity's performance relative to the target. For example, the impact-factor-insight system 102 can determine focus areas 216a for the entity 200a based on the impact factor scores 210a and the relative performance 212a associated with the entity 200a. Similarly, the impact-factor-insight system 102 can determine focus areas 216b for the entity 200b based on the impact factor scores 210b and the relative performance 212b associated with the entity 200b. The focus areas for each entity may be different according to the specific impact factors and the relative performances of the entities.

To provide a suggested impact factor, in one or more embodiments, the impact-factor-insight system 102 provides an interactive indicator for the impact factor. Specifically, the impact-factor-insight system 102 can cause a client device of the entity (e.g., the administrator device 108) to display an interactive impact-factor indicator as a selectable graphical-user-interface element, as shown by the focus areas 216a, 216b of FIG. 2. In one or more embodiments, the impact-factor-insight system 102 provides a plurality of interactive impact-factor indicators to the client device of the entity. The impact-factor-insight system 102 can determine which, and how many, interactive impact-factor indicators to provide based on, but not limited to, scores associated with the corresponding impact factors, preferences of the entity, a ranking threshold, or available space within a graphical user interface.

Once the impact-factor-insight system 102 has provided interactive impact-factor indicators to an administrator device, the impact-factor-insight system 102 can receive a selection of an indicator. In one or more embodiments, after providing one or more interactive indicators to an entity device, an administrator or other user associated with the entity can select an indicator. The impact-factor-insight system 102 can then receive the selection of an interactive indicator associated with an impact factor, thereby requesting that the impact-factor-insight system 102 provide additional information or options associated with the impact factor.

Additionally, the impact-factor-insight system 102 can provide recommended actions related to the corresponding impact factor. For instance, in response to a selection of an interactive indicator corresponding to an impact factor, the impact-factor-insight system 102 can determine one or more actions that the entity can take with respect to the impact factor. For example, the impact-factor-insight system 102 can determine actions that the entity can perform to improve the entity's performance relative to the corresponding impact factor. The impact-factor-insight system 102 can then provide the actions to the client device of the entity as recommendations, which the entity can then perform.

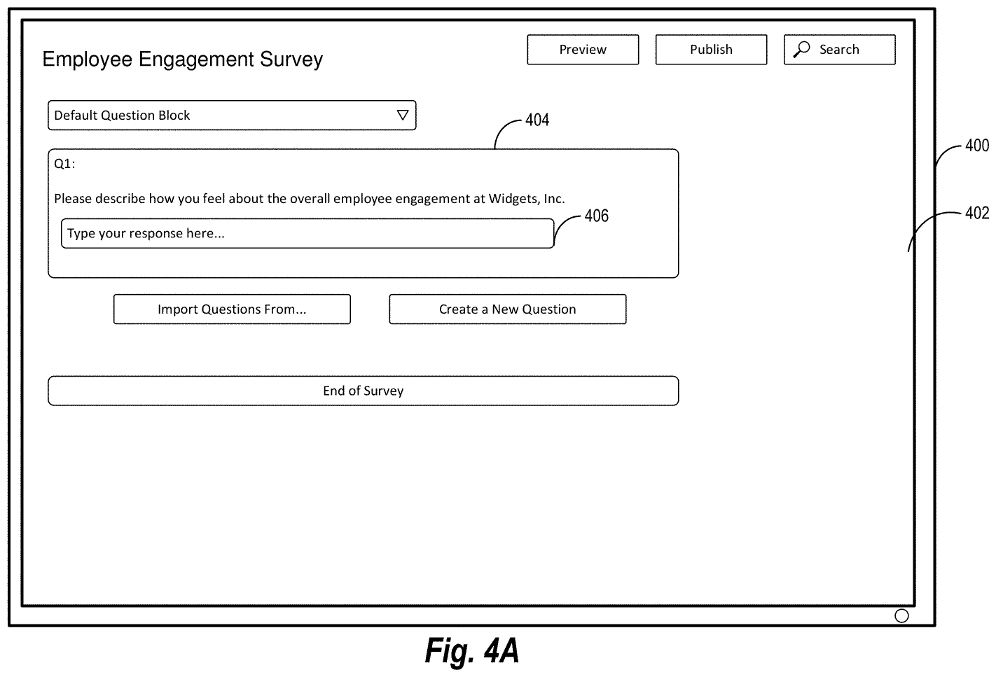

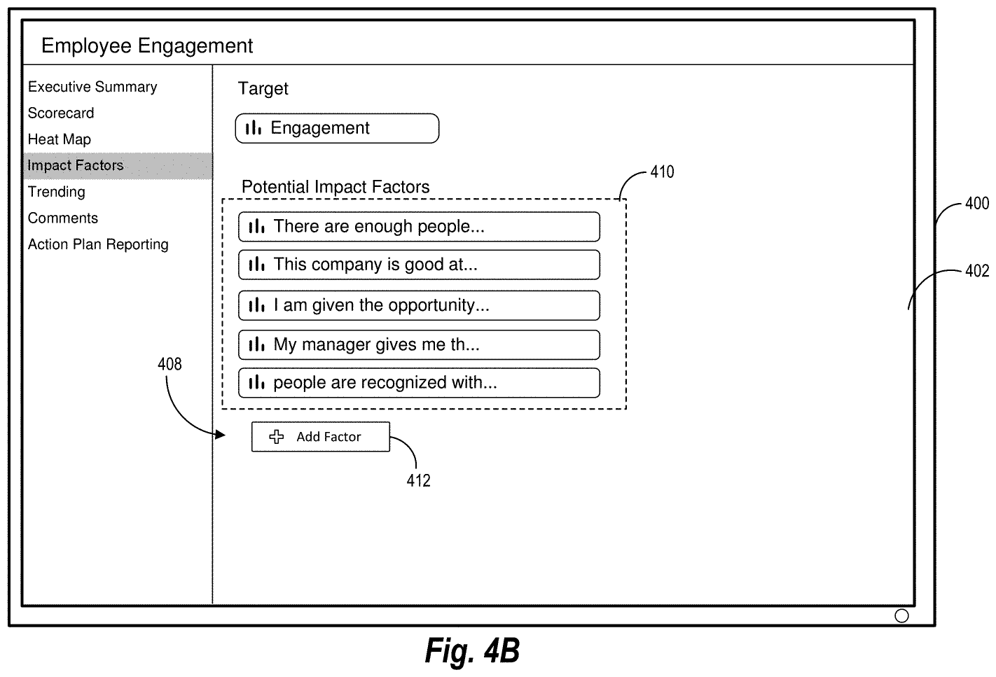

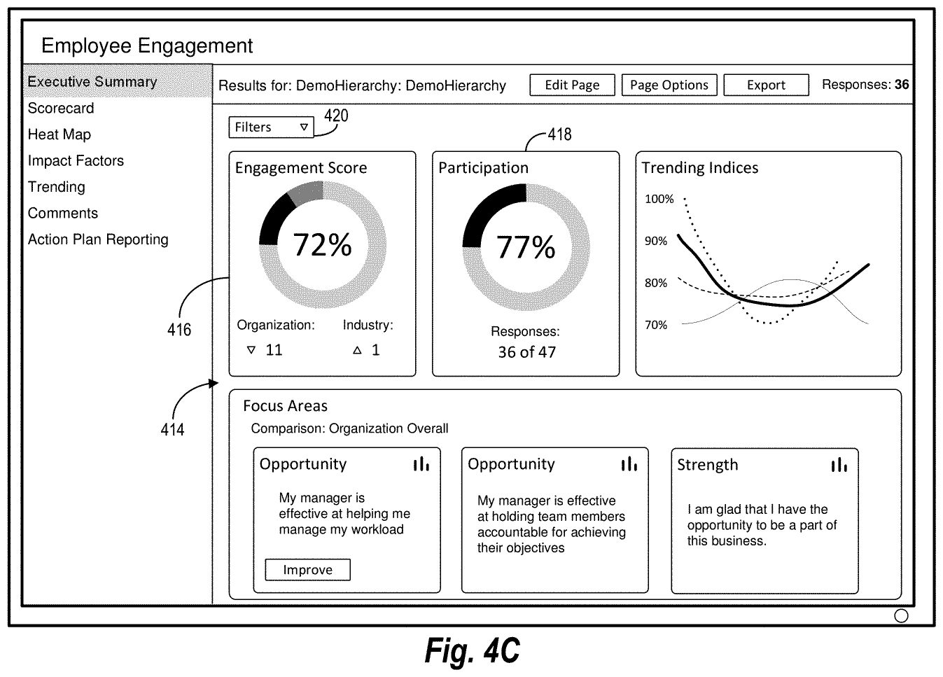

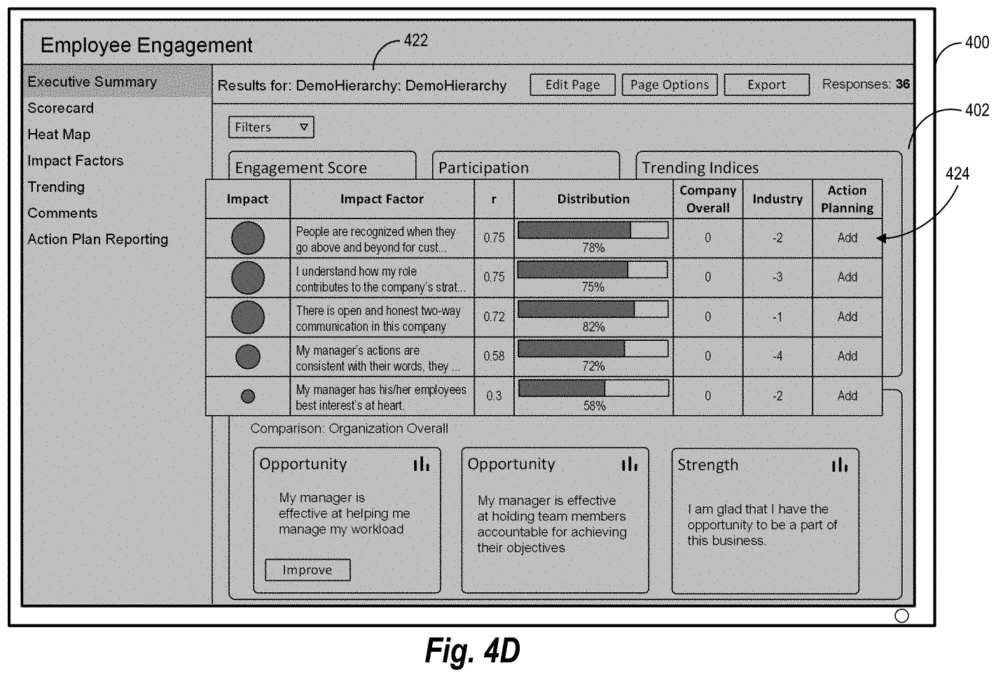

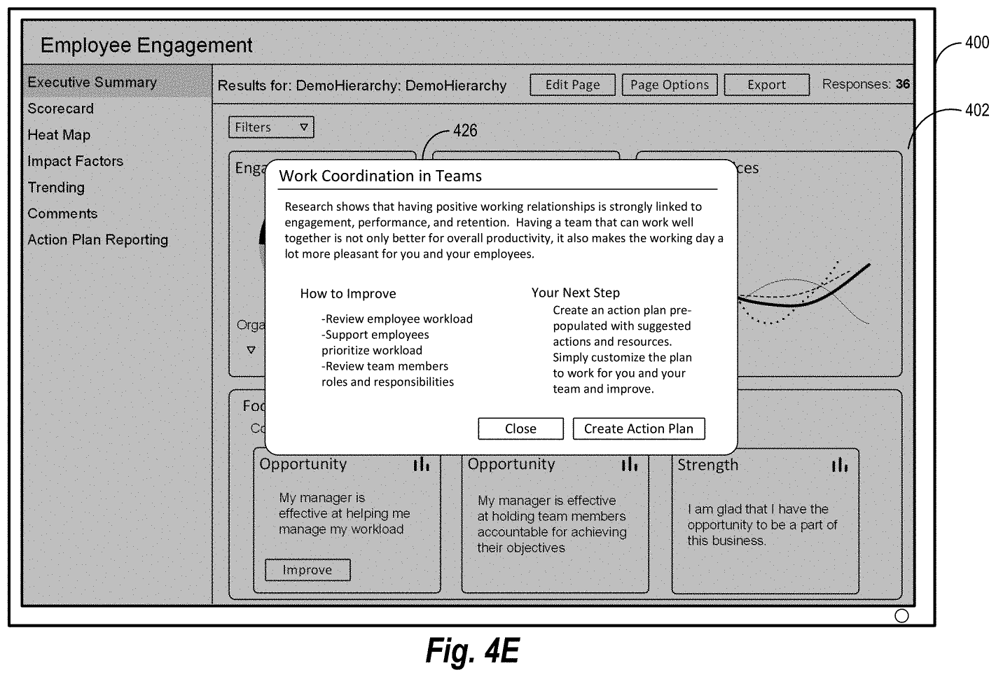

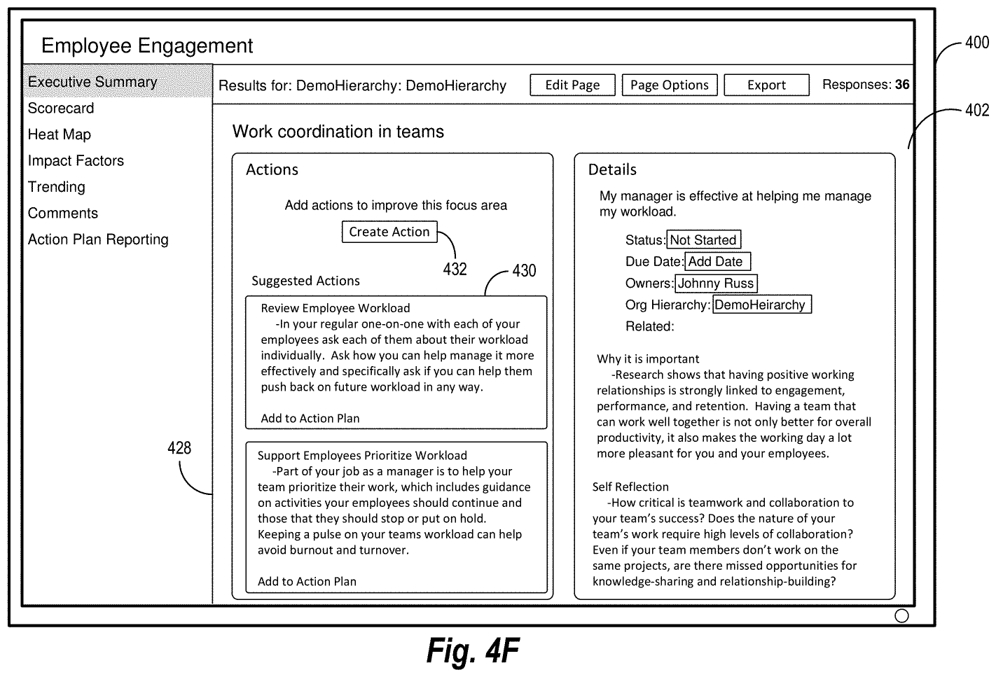

In one or more additional embodiments, the impact-factor-insight system 102 tracks the progress of the entity in connection with one or both entity's performance with regard to the impact factor falls under a threshold or benchmark or other reference of actions and impact factors. To illustrate, the impact-factor-insight system 102 can track the entity's performance of one or more actions. The impact-factor-insight system 102 can also use follow-up information associated with one or both of the action and impact factor to determine a degree to which the impact factor affects or relates to a target. Furthermore, the impact-factor-insight system 102 can update the impact-factor score and/or the relative-performance score based on the follow-up information. Accordingly, the impact-factor-insight system 102 can continuously monitor and rank impact factors corresponding to the target to provide up-to-date, easily accessible information to the entity. FIGS. 4A-4F and the corresponding description below provide additional detail related to user interfaces for presenting interactive impact-factor indicators to an entity.

In accordance with one or more embodiments, FIGS. 3A-3B illustrate processes for the impact-factor-insight system 102 generating impact-factor scores for a set of impact factors and then ranking the impact factors. In particular, FIG. 3A illustrates the impact-factor-insight system 102 generating impact-factor scores for impact factors indicating relationships between the impact factors and a target. FIG. 3B illustrates the impact-factor-insight system 102 ranking the impact factors based on the impact-factor scores and relative performance of the entity for the impact factors.

As illustrated in FIG. 3A, the impact-factor-insight system 102 can identify a plurality of unstructured responses 302a-302n for an electronic survey question. In one or more embodiments, the unstructured responses 302a-302n include open-ended text responses with varying numbers of words and sentences, varying topics, and/or varying word usage depending on the respondents. For example, in response to an electronic survey question requesting feedback regarding employee engagement at the company, the unstructured responses 302a-302n can include text composed by different employees addressing a number of different issues written in the employees' own words.

As previously described, the impact-factor-insight system 102 can use data from one or more input devices that capture respondent sentiment, state-of-mind, or feeling in response to some stimulus. For example, the impact-factor-insight system 102 can capture video of a respondent while the respondent views or experiences an event (e.g., live media event, digital media event) or in conjunction with answering a survey question. In one or more embodiments, the impact-factor-insight system 102 can capture biometric data of a respondent and then infer response data from the captured biometric data. To illustrate, the impact-factor-insight system 102 can use heart-rate sensors, blood pressure sensors, body temperature sensors, movement sensors, or other sensors that can detect respondent body responses (e.g., involuntary responses such as heart rate or blood pressure).

The impact-factor-insight system 102 can analyze the unstructured responses 302a-302n using machine-learning techniques or other computer language-analysis techniques to parse and interpret the unstructured responses 302a-302n. In one or more embodiments, the impact-factor-insight system 102 generates sentiment scores and/or textual quality scores for the unstructured responses 302a-302n to determine the content and characteristics of the content of each unstructured response. To analyze unstructured text and/or to generate response summaries of the unstructured responses, in some embodiments, the impact-factor-insight system 102 can use one or more methods described in R. David Norton et al., Intelligently Summarizing and Presenting Textual Responses with Machine Learning, U.S. patent application Ser. No. 16/289,398 (filed Feb. 28, 2019), the entirety of which is hereby incorporated by reference.

In one or more embodiments, the impact-factor-insight system 102 analyzes the unstructured responses 302a-302n to identify a set of impact factors 304a-304n related to a target 306 for the entity. For instance, as previously described, the impact-factor-insight system 102 can identify impact factors 304a-304n mentioned in the unstructured responses 302a-302n in connection with the target 306. To illustrate, the impact-factor-insight system 102 can use machine-learning to extract words or phrases that either explicitly indicate an impact factor or contextually refer to an impact factor.

As mentioned above, the impact-factor-insight system 102 can analyze freeform text using natural language processing, such as by inferring meaning from text based on phrases or words in the text and based on context of the text. In one or more additional embodiments, the impact-factor-insight system 102 can analyze captured video to determine response data based on respondent facial expressions, gestures, or other indicators of a response. To illustrate, the impact-factor-insight system 102 can determine that a respondent is happy by analyzing captured video and determining that the respondent is smiling. In the case of biometric data, the impact-factor-insight system 102 can infer that a respondent is happy, sad, disappointed, uncomfortable, angry, etc., based on measurements and understanding of human bodily responses to certain stimuli. The impact-factor-insight system 102 can also use more than one type of unstructured response data to determine a combined response for a particular survey question (e.g. by combining structured or unstructured survey question data with captured video/biometric data). In some embodiments, the impact-factor-insight system 102 analyzes video, biometric data, or other unstructured responses as described by Larry Dean Cheesman, Conducting Digital Surveys That Collect and Convert Biometric Data Into Survey Respondent Characteristics, U.S. patent application Ser. No. 15/582,180 (filed Apr. 28, 2017), the entirety of which is hereby incorporated by reference.

In some instances, as briefly mentioned previously, the impact-factor-insight system 102 can identify one or more pre-defined impact factors from the unstructured responses 302a-302n. Specifically, an administrator or other user associated with the entity (or associated with the impact-factor-insight system 102) can define a set of impact factors by creating a set of labels for the impact factors. The impact-factor-insight system 102 can then determine whether any of the pre-defined impact factors are indicated in one or more of the unstructured responses 302a-302n. The impact-factor-insight system 102 can then map the corresponding responses to the labels for the indicated impact factors.

Alternatively, the impact-factor-insight system 102 can identify one or more new impact factors from the unstructured responses 302a-302n. In particular, the impact-factor-insight system 102 can analyze the unstructured responses 302a-302n to determine whether the unstructured responses 302a-302n discuss any previously unidentified topics related to a target. Additionally, the impact factors 304a-304n can include one or more pre-defined impact factors and one or more new impact factors from the unstructured responses 302a-302n. The impact-factor-insight system 102 can also identify the target 306 based on the unstructured responses 302a-302n, the electronic survey question, or a target label set by an administrator.

FIG. 3A illustrates the impact-factor-insight system 102 generating impact-factor scores 308a-308n for the impact factors 304a-304n. For example, the impact-factor-insight system 102 can determine a correlation between each impact factor and the target 306. The impact-factor-insight system 102 can use this correlation to determine an impact-factor score for the impact factor. In one or more embodiments, the impact-factor-insight system 102 generates an impact-factor score for an impact factor by calculating an R-squared coefficient for the impact factor and the target. To determine such an R-squared coefficient, in some embodiments, the impact-factor-insight system 102 executes a regression calculation indicating the proportion of the variance in a dependent variable that is predictable from an independent variable.

Furthermore, the impact-factor-insight system 102 can determine the R-squared coefficient by calculating the correlation using filtered response data when N of currently filtered data is greater than or equal to a threshold. For example, the impact-factor-insight system 102 can filter for specific response data to use in generating the impact-factor scores 308a-308n (e.g., for a specific time period or based on a manually selected filter, for a specific percentage of responses). Alternatively, when N is less than the threshold, the impact-factor-insight system 102 can instead calculate the correlation using unfiltered data. In one or more embodiments, the impact-factor-insight system 102 uses R-squared regression analysis as described by Norman R. Draper and Harry Smith, Applied Regression Analysis (1998), the entirety of which is hereby incorporated by reference.

In one or more alternative embodiments, the impact-factor-insight system 102 generates the impact-factor scores 308a-308n using a relative weights analysis. In some cases, to prevent inflating the importance of unimportant impact factors, the impact-factor-insight system 102 can determine a correlation between an impact factor and the target 306 by controlling for other impact factors. For example, the impact-factor-insight system 102 can determine relative weights for each impact factor based on examples where the impact factors and the target change at different amounts. More specifically, if a value associated with a first impact factor increases while a value associated with a second impact factor stays the same with the target 306 moving, the impact-factor-insight system 102 can determine that the first impact factor may at least partially cause the movement of the target 306. To illustrate, if response data indicates that manager friendliness (impact factor) improves, office cleanliness (impact factor) stays the same, and overall employee engagement (the target) improves, the impact-factor-insight system 102 can determine that manager friendliness at least partially causes the movement of overall employee engagement. The impact-factor-insight system 102 can then generate the impact-factor score for the corresponding impact factor using the relative weight (instead of the R-squared value).

As further illustrated in FIG. 3B, after the impact-factor-insight system 102 generates the impact-factor scores 308a-308n, the impact-factor-insight system 102 ranks the impact factors 304a-304n for the entity. In addition to generating the impact-factor scores 308a-308n, the impact-factor-insight system 102 can also generate relative-performance scores 310a-310n for the entity with respect to the impact factors 304a-304n. In particular, the relative-performance scores 310a-310n indicate the performance of the entity for the impact factors 304a-304n relative to one or both of additional entities and a performance scale. To illustrate, the impact-factor-insight system 102 can generate a relative-performance score to indicate how well the entity performed for a given impact factor relative to other entities that also performed for the given impact factor. As an example, a relative-performance score can include a ranking of the entity's performance relative to other entities in manager friendliness (e.g., third out of seven entities).

The impact-factor-insight system 102 can also indicate a difference between the entity's performance and a reference point for the given impact factor. For example, the impact-factor-insight system 102 can generate relative-performance scores based on how well the entity performs for an impact factor on a performance rating or performance scale determined from the unstructured responses 302a-302b. If the entity performs well on the scale, the difference between the entity's performance and the reference point may be small, even if the entity performs poorly relative to other entities. To illustrate, if the entity performs poorly relative to other entities for an impact factor of office cleanliness (e.g., lowest of a peer group of entities), but 80% of the respondents are happy with the entity's performance, the difference between the entity's performance and the reference point (e.g., 100%) may be smaller than if 40% of respondents are happy with the entity's performance. Similarly, if the entity performs well relative to other entities for an impact factor of employee benefits, but only 30% of respondents are happy with the entity's performance relative to office cleanliness, the difference between the entity's performance and the reference point may be significant.

In one or more embodiments, the impact-factor-insight system 102 can determine a performance scale or performance rating from the unstructured responses 302a-302n based on contextual data from the unstructured responses 302a-302n. For instance, the impact-factor-insight system 102 can determine that the performance scale includes emotional ratings based on emotional phrases included in the unstructured responses 302a-302n, such as “happy,” “not happy,” “dissatisfied,” “upset.” Additionally, the impact-factor-insight system 102 can determine tone of the unstructured responses 302a-302n based on the words/phrases used, including whether respondents are angry or happy based on sentiment scores. The impact-factor-insight system 102 can then use this information to determine a relative performance scale to use in analyzing entity performance, for example, by assigning numerical values to inferred ratings from the unstructured responses 302a-302n.

In one or more embodiments, after determining the impact-factor scores 308a-308n for the impact factors and the relative-performance scores 310a-310n for the entity, the impact-factor-insight system 102 can determine ranked impact factors 312. In particular, the impact-factor-insight system 102 can rank the impact factors 304a-304n according to the degree to which each impact factor exhibits a causal correlation to the target 306, exhibits causation of the exhibit 306, or demonstrates some other relationship to the target 306. For example, the impact-factor-insight system 102 can generate a priority score for each impact factor based on the corresponding impact-factor score and the corresponding relative-performance score. The impact-factor-insight system 102 thus takes into account how important each impact factor is in terms of the target 306 as well as the performance of the entity for each impact factor.

As an example, the impact-factor-insight system 102 can generate a priority score for an impact factor by multiplying the impact-factor score (e.g., the R-squared value) of the impact factor by the relative-performance score (e.g., a score based on the entity's performance relative to other entities and/or on a performance scale). The impact-factor-insight system 102 can then rank the impact factors according to the priority scores. In one or more embodiments, a higher priority score indicates a higher priority, and thus, a better rank (e.g., a highest priority score corresponds to a top rank). Accordingly, the impact-factor-insight system 102 can rank a number of impact factors corresponding to a target for an entity based on unstructured responses to an electronic survey question and based on entity performance for the impact factors.

In one or more embodiments, the impact-factor-insight system 102 also monitors performance associated the “return on investment” for each impact factor. For example, the impact-factor-insight system 102 can determine whether performance relative to one impact factor changed the entity's performance relative to another impact factor. To illustrate, if the entity focuses on improving performance related to a first impact factor, the impact-factor-insight system 102 can determine that the efforts to improve performance related to the first impact factor also correlated to an improved performance of a second factor over the same period of time (e.g., focusing on cleanliness resulted in improved satisfaction over the next three months), or whether the impact factor had no effect on another impact factor. The impact-factor-insight system 102 can further determine how much effort the entity needs to exert for an impact factor to modify performance for the target relative to other impact factors. The impact-factor-insight system 102 can then rank a particular impact factor based on its effect on other impact factors and the overall effort required.

In one or more embodiments, the impact-factor-insight system 102 can use ranked impact factors to assist an entity with performance relative to the impact factors and a corresponding target. In accordance with one or more embodiments, FIGS. 4A-4F illustrate an administrator device 400 presenting graphical user interfaces for administering an electronic survey and analyzing response data associated with the electronic survey. For example, FIG. 4A illustrates the administrator device 400 presenting a graphical user interface for generating and administering an electronic survey. FIGS. 4B-4F illustrate the administrator device 400 presenting graphical user interfaces for presenting analysis of response data and impact factors corresponding to a target.

As mentioned, FIG. 4A illustrates that the impact-factor-insight system 102 can provide a graphical user interface for generating and administering an electronic survey. In particular, the administrator device 400 can include an administrator application 402 that allows an administrator associated with an entity to manage electronic surveys. For example, the administrator application 402 can provide tools for generating an electronic survey question 404. The administrator can use the tools to generate the electronic survey question 404 to request information from a plurality of respondents.

As mentioned previously, for example, the electronic survey question 404 can request that employees of the entity provide feedback related to employee engagement at the entity. As illustrated in FIG. 4A, the administrator device 400 can insert the electronic survey question 404 into an electronic survey along with a text field 406 for entering responses based on user input from an administrator. More specifically, the text field 406 allows respondents to provide open-ended text responses to the electronic survey question 404 in their own words. Accordingly, when the administrator publishes the electronic survey with the electronic survey question 404 to a plurality of respondents, the impact-factor-insight system 102 can provide the electronic survey to a plurality of respondent devices.

Although FIG. 4A illustrates that the impact-factor-insight system 102 provides a graphical user interface for generating and administering and electronic survey, the impact-factor-insight system 102 can alternatively communicate with or receive data from a third-party system selected by an entity to generate and/or administer the electronic survey. For example, a third-party system may administer an electronic survey including the electronic survey question 404 to a plurality of respondents. The impact-factor-insight system 102 can communicate with the third-party system to obtain response data for the electronic survey. The impact-factor-insight system 102 can then analyze the response data for providing recommendations of impact factors to the entity.

As mentioned, FIGS. 4B-4F illustrate the administrator device 400 presenting graphical user interfaces for visualizing analysis of response data and impact factors corresponding to a target. In one or more embodiments, the administrator device 400 displays entity management tools within graphical user interfaces of the administrator application 402 for managing aspects of the entity in connection with electronic surveys administered by or for the entity. For example, the administrator application 402 can include a graphical user interface associated with a target (e.g., “Employee Engagement”). The graphical user interface can thus include information that is specific to the target in connection with one or more electronic surveys related to the target.

FIG. 4B illustrates the administrator device 400 presenting an impact factor interface 408 comprising information associated with impact factors related to the target. In particular, the impact-factor-insight system 102 can provide tools for displaying the target as well as potential impact factors 410 associated with the target. As shown in FIG. 4B, the potential impact factors 410 can include a plurality of factors that the impact-factor-insight system 102 has identified based on responses associated with an electronic survey and/or based on input from a user associated with the entity. To illustrate, the impact-factor-insight system 102 can identify impact factors based on structured responses, unstructured responses, or administrator input. The impact-factor-insight system 102 can also identify the potential impact factors 410 based on a plurality of electronic surveys or electronic survey questions relating to the target.

In one or more embodiments, in response to identifying a potential impact factor from one or more responses to an electronic survey, the impact-factor-insight system 102 can generate a graphical-user-interface element (e.g., an icon or button) associated with the potential impact factor. The impact-factor-insight system 102 can add the graphical-user-interface element to the impact factor interface 408 in a list of graphical-user-interface elements for the potential impact factors 410. Upon detecting a user selection of one such element, in some embodiments, the administrator device 400 presents additional information associated with each potential impact factor. For instance, upon receiving an indication of a user selection of an element, the impact-factor-insight system 102 can provide for display on the administrator device 400 one or more responses that included the corresponding potential impact factor. Additionally, the impact-factor-insight system 102 may also remove a potential impact factor from the potential impact factors 410 in response to a user input (e.g., by an administrator using the administrator device 400).

The impact-factor-insight system 102 may also add additional potential impact factors in response to user input. For example, the impact-factor-insight system 102 may add impact factors to the potential impact factors 410 in response to a user input selecting one or more topics discussed in the responses that may not be included in the potential impact factors 410. Additionally, the impact-factor-insight system 102 may add impact factors in response to a selection of an add factor element 412 and a manual input or a selected input to enter concepts into the potential impact factors 410. The impact-factor-insight system 102 can then look for such concepts in existing or future responses to the electronic survey question (or other electronic survey questions related to the target). The impact-factor-insight system 102 can thus supplement machine-learning techniques for identifying potential impact factors for the target with human-identified potential impact factors.

When the impact-factor-insight system 102 has identified at least one impact factor for a target, the impact-factor-insight system 102 can then analyze the responses to determine a correlation between the identified impact factor(s) and the target. For instance, the impact-factor-insight system 102 can determine a degree to which each impact factor affects or exhibits a causal correlation with the target and generate impact-factor scores for the impact factors. Additionally, the impact-factor-insight system 102 can generate relative-performance scores of the entity for the impact factors using the response data.

FIG. 4C illustrates that the administrator device 400 includes a summary interface 414 displaying a summary of information related to the target. In particular, the impact-factor-insight system 102 can analyze the response data to rank impact factors for the target. The impact-factor-insight system 102 can also provide summary information such as trends, comparisons to other entities, response summaries, demographic information, question summaries, or other information related to the target and/or electronic surveys. In one or more embodiments, the impact-factor-insight system 102 also provides tools for additional entity management operations, such as, but not limited to, action planning tools to create plans of action related to the target and/or impact factors related to the target. As described in more detail below, the impact-factor-insight system 102 can also obtain follow-up information from the entity in connection with the target and then use the follow-up information to update summary information in the summary interface 414.

As shown in FIG. 4C, the impact-factor-insight system 102 can provide a performance-summary indicator 416 of the performance of the entity. The performance-summary indicator 416 can include a summary of the entity's performance in relation to the target. For example, the impact-factor-insight system 102 can determine the overall performance of the entity relative to the target (e.g., how well a particular manager is performing in relation to employee engagement). The impact-factor-insight system 102 can generate a target score (e.g., engagement score for employee engagement) from the response data and insert the target score in the performance-summary indicator 416. The performance-summary indicator 416 can also include performance of the entity relative to other entities and/or to past performance of the entity.

As shown in FIG. 4C, in addition to generating the performance-summary indicator 416, the impact-factor-insight system 102 provides an interactive impact factor indicator such as an impact-factor-summary indicator 418. In some embodiments, the administrator device 400 presents an impact-factor-summary indicator as a card or summary graphic. The impact-factor-summary indicator 418 can include information about a particular impact factor associated with the target. For example, as shown, the impact-factor-summary indicator 418 of FIG. 4C includes information associated with an impact factor of “participation” related to employee engagement. The impact-factor-summary indicator 418 can include information such as a performance of the entity for the given impact factor, as well as the total number of responses that referenced the impact factor. The impact-factor-summary indicator 418 can also include other information about the impact factor, such as the entity's performance relative to other entities or to a history of the entity.

As previously described, the impact-factor-insight system 102 can rank the impact factors associated with a target for an entity. In one or more embodiments, the impact-factor-insight system 102 determines one or more impact-factor-summary indicators to present within the summary interface 414 based on the corresponding rankings of the impact factors. For instance, as shown in FIG. 4C, the impact-factor-insight system 102 generates or provides for display the impact-factor-summary indicator 418 for a “participation” impact factor based on a ranking associated with the “participation” impact factor. To illustrate, the “participation” impact factor may have the highest ranking for the entity in connection with the target, and thus, the impact-factor-insight system 102 can provide the corresponding impact-factor-summary indicator for display within the administrator device 400. In other embodiments, the impact-factor-insight system 102 may generate more than one impact-factor-summary indicator to provide to the administrator device 400, such as, but not limited to, based on administrator preferences, availability of additional impact factors, or score thresholds associated with the impact factors.

In one or more embodiments, the impact-factor-insight system 102 provides the option for an administrator to apply one or more filters to the data shown in the summary interface 414. In some embodiments, the impact-factor-insight system 102 can provide significant control to the administrator device 400 regarding what information to analyze and/or present in connection with a target based on administrator input. For instance, the summary interface 414 can include a filter option 420, such as a dropdown menu or a plurality of dropdown menus associated with various types of filters. To illustrate, based on user input interacting with the filter option 420, the impact-factor-insight system 102 can filter responses by location (e.g., country, region, store location), department, age, language, gender, or other categories depending on the type of response data, the entity, or other factors.

Additionally, the impact-factor-insight system 102 can filter impact factors based on various characteristics of text in the responses, including numeric (e.g., sentiment) or categorical (e.g., emotion) characteristics. For example, the impact-factor-insight system 102 can filter for impact factors based on responses that include specific emotions (e.g., angry responses or happy responses), based on volume of responses (e.g., 50 or more), newness of responses, percentage of responses that include an impact factor, or whether the impact factors match up with a specified operation strategy associated with the entity. By filtering according to various characteristics, the impact-factor-insight system 102 provides flexible filtering tools for the entity to address specific groups of respondents with high specificity.

In response to determining that a filter is selected, the impact-factor-insight system 102 can then filter the impact factors according to the selected filter. For instance, the impact-factor-insight system 102 can determine responses that correspond to the selected filter and then recalculate the information for presentation in the summary interface 414 according to the filter. For instance, in response to receiving an indication of a selected location filter, the impact-factor-insight system 102 can analyze responses corresponding to the selected location and then generate summary information based on those responses. The performance-summary indicator 416 and the impact-factor-summary indicator 418 can thus display information about performance/impact factors corresponding to the filtered responses, including the ranking of the impact factors and relative performance of the entity. If a filter does not apply to any responses, the impact-factor-insight system 102 may instead display no information or information relevant to all responses.

In one or more embodiments, the performance-summary indicators and impact-factor-summary indicators are interactive. Based on receiving a selection of such an indicator, in some cases, the impact-factor-insight system 102 provide additional information associated with the selected indicator. For instance, as shown in FIG. 4D, upon receiving an indication of a selection of the impact-factor-summary indicator 418, the impact-factor-insight system 102 can provide for display, within a graphical user interface of the administrator application 402, a ranked list 422 of impact factors for the target (e.g., as an overlay within the summary interface 414 or in a separate interface). The ranked list 422 can include each impact factor associated with the target, including impact factors determined from unstructured responses from respondents. The ranked list 422 can also indicate the impact that each impact factor has in relation to the target (e.g., a causal correlation based on an impact-factor score), as well as other information indicating correlation values, entity performance, and industry performance.

Furthermore, the impact-factor-insight system 102 can provide an option to begin planning actions relative to an impact factor (e.g., action planning option 424). For instance, the impact-factor-insight system 102 can determine that the entity can perform various options associated with an impact factor to help improve the entity's performance relative to the impact factor. The actions may be directly related to an impact factor or a plurality of impact factors. In the embodiment of FIG. 4E, upon detecting a user selection of the action planning option 424, the administrator application 402 displays information about establishing an action plan. More specifically, FIG. 4E illustrates the administrator device 400 presenting an action planning overlay 426 within a graphical user interface detailing information about establishing an action plan for a corresponding impact factor and/or the target.

As further illustrated in FIG. 4E, in one or more embodiments, the impact-factor-insight system 102 provides an option to create an action plan within a graphical user interface in the administrator application 402. As shown in FIG. 4F, upon receiving an indication of a user selection of an option to create an action plan, the impact-factor-insight system 102 provides one or more suggested actions (e.g., suggested action 430) associated with an impact factor or a target and options to add the suggested action(s) to the action plan. The impact-factor-insight system 102 can also provide details describing the action plan including, but not limited to, a status of the action plan, a due date of the action plan, an owner of the action plan (e.g., implementing user), or an entity. The impact-factor-insight system 102 can also provide selectable options to allow a user to add or modify each of the details for the action plan.

In one or more embodiments, in connection with identifying impact factors for a target, the impact-factor-insight system 102 can also determine the recommended actions associated with the impact factors. For example, the impact-factor-insight system 102 determines actions associated with an impact factor based on the unstructured responses. To illustrate, the impact-factor-insight system 102 can determine an action based on words or phrases within one or more responses, such as suggestions provided within the responses or specific areas that responses indicate should be improved. The impact-factor-insight system 102 can also determine suggested actions based on historical actions taken for the impact factor in connection with the entity or other entities.

The impact-factor-insight system 102 can also provide an action option 432 to create an action for an action plan. For example, in response to a user input selecting the action option 432, the impact-factor-insight system 102 can create a new action for the action plan. The impact-factor-insight system 102 can then receive and display details associated with the action (e.g., based on user input or based on previously stored details for the action plan or for the entity), including steps that the entity should take in completing the action, who is involved, etc.

Once the action plan is complete, the impact-factor-insight system 102 can display information about the action plan to the administrator. For example, the impact-factor-insight system 102 can display the action plan or a summary of the action plan in the summary interface 414. The impact-factor-insight system 102 can also perform operations to follow up on the action plan, including providing notifications, tracking a status of the actions performed and the status of the action plan overall, or changes to the action plan.

Additionally, the impact-factor-insight system 102 can update performance data for the entity relative to one or more impact factor(s) and/or the target based on the action plan. To illustrate, if the entity performs one or more actions from the action plan, the impact-factor-insight system 102 can determine that the performed actions change the entity's performance scores based on additional feedback from respondents. More particularly, the impact-factor-insight system 102 may resubmit the electronic survey question to respondents or otherwise allow the respondents to provide new feedback corresponding to the entity. The impact-factor-insight system 102 can then update the entity's performance scores for the target and/or impact factors based on the updated responses.

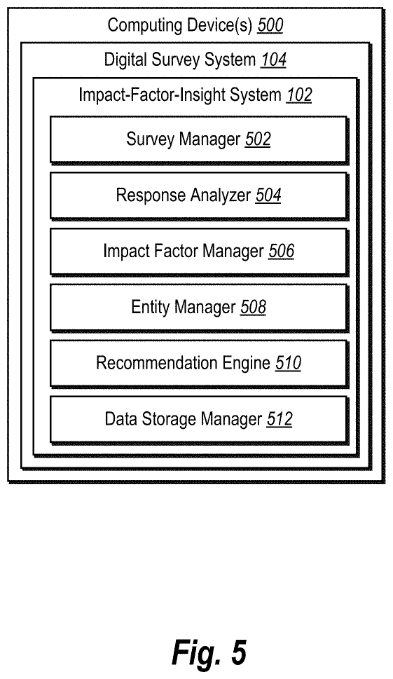

FIG. 5 illustrates an example embodiment of a system environment that includes the digital survey system 104 and the impact-factor-insight system 102 of FIG. 1. Specifically, the digital survey system 104 operates on computing device(s) 500. The digital survey system 104 includes the impact-factor-insight system 102. The impact-factor-insight system 102 includes a survey manager 502, a response analyzer 504, an impact factor manager 506, an entity manager 508, a recommendation engine 510, and a data storage manager 512. Although the impact-factor-insight system 102 is depicted as having various components, the impact-factor-insight system 102 can have any number of additional or alternative components. Alternatively, one or more components of the impact-factor-insight system 102 can be combined into fewer components or divided into more components. Additionally, although the impact-factor-insight system 102 may be on any number of computing devices or on a single computing device.

In one or more embodiments, each of the components and subcomponents of the impact-factor-insight system 102 can be in communication with one another using any suitable communication technologies. It will be recognized that although the subcomponents of the impact-factor-insight system 102 are shown to be separate in FIG. 5, any of the subcomponents can be combined into fewer components, such as into a single component, or divided into more components as can serve a particular implementation. Furthermore, although the components of FIG. 5 are described in connection with the impact-factor-insight system 102, at least some of the components for performing operations in conjunction with the impact-factor-insight system 102 described herein can be implemented on other devices and/or with other systems.

The components of the impact-factor-insight system 102 can include software, hardware, or both. For example, the components of the impact-factor-insight system 102 can include one or more instructions stored on computer-readable storage mediums and executable by processors of one or more computing devices. When executed by the one or more processors, the computer-executable instructions of the impact-factor-insight system 102 can cause the computing device(s) 500 to perform the survey administration and response analysis processes described herein. Alternatively, the components of the impact-factor-insight system 102 can comprise hardware, such as a special purpose processing device to perform a certain function or group of functions. Additionally, the components of the impact-factor-insight system 102 can comprise a combination of computer-executable instructions and hardware.

Furthermore, the components of the impact-factor-insight system 102 performing the functions described herein with respect to survey administration and response analysis can, for example, be implemented as part of a stand-alone application, as a module of an application, as part of a suite of applications, as a plug-in for applications including content creation applications, as a library function or functions that can be called by other applications, and/or as a cloud-computing model. Thus, various components of the impact-factor-insight system 102 can be implemented as part of a stand-alone application on a personal computing device or a mobile device. For example, the components of the impact-factor-insight system 102 can be implemented in any application that allows the creation and administration of surveys, response analysis, and action planning, as can serve a particular embodiment.

As illustrated, the impact-factor-insight system 102 includes the survey manager 502 that facilitates the creation and administration of electronic surveys. For example, the survey manager 502 can allow a user to create an electronic survey including one or more electronic survey questions, send the electronic survey to one or more computing devices, and obtain response data for the electronic survey. The survey manager 502 can also manage information about respondents that correspond to the responds data for the electronic survey.

Additionally, the impact-factor-insight system 102 can include a response analyzer 504 to analyze responses to an electronic survey question. Specifically, the response analyzer 504 can use machine-learning or other language analysis techniques to determine content and characteristics of the responses. For instance, the response analyzer 504 can interpret the meaning of responses for identifying impact factors associated with a target. Additionally, the response analyzer 504 can analyze responses to determine characteristics for filtering the responses in connection with providing suggested impact factors.

The impact-factor-insight system 102 can also include an impact factor manager 506 to facilitate the management of impact factors related to a target. For example, the impact factor manager 506 can generate impact-factor scores for impact factors based on the correlation between the impact factors and the target. The impact factor manager 506 can also use filtering information from the response analyzer 504 to determine which impact factors to analyze at any given time.

The impact-factor-insight system 102 can further include the entity manager 508. The entity manager 508 can manage an identity of an entity. The entity manager 508 can also determine performance of the entity related to impact factors and a target. The entity manager 508 can also generate relative-performance scores for impact factors and/or a target in connection with ranking the impact factors (e.g., by communicating with the recommendation engine 510).

Additionally, the impact-factor-insight system 102 can include the recommendation engine 510 to provide recommendations of impact factors to a user. For example, the recommendation engine 510 can rank impact factors for an entity based on the impact-factor scores from the impact factor manager 506 and the relative-performance scores from the entity manager 508. The recommendation engine 510 can then use the rankings to determine one or more impact factors to recommend to a user to improve the entity's performance with respect to the target. The recommendation engine 510 can also provide recommendations of actions to the entity in connection with impact factors.

The impact-factor-insight system 102 can also include the data storage manager 512 to store data associated with the operations of survey administration and response analysis. For example, the data storage manager 512 can communicate with other components of the impact-factor-insight system 102 to store data including survey questions, survey responses, impact-factor scores, relative-performance scores, and impact-factor rankings. The data storage manager 512 can also communicate with the other components of the impact-factor-insight system 102 to provide stored data for performing survey administration and response analysis.

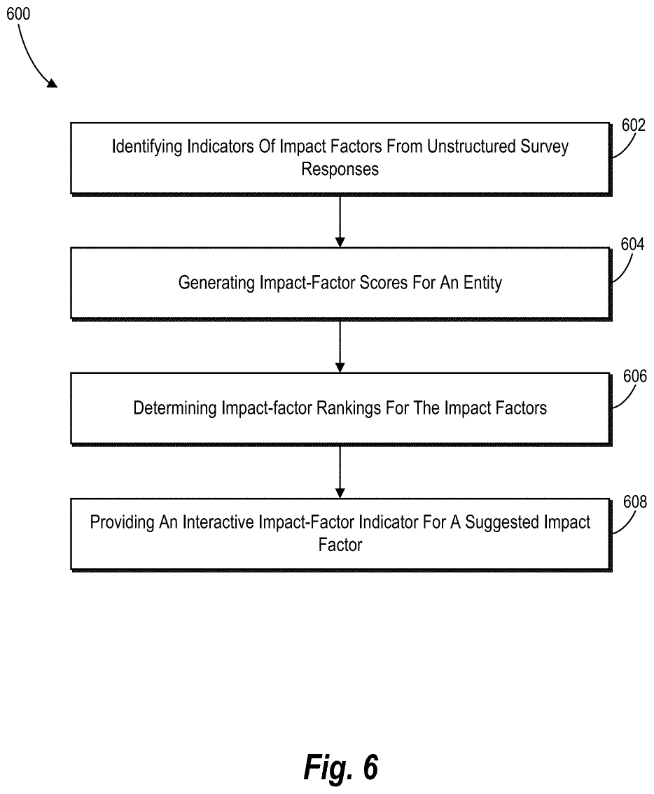

Turning now to FIG. 6, this figure illustrates a flowchart of a series of acts 600 of providing interactive insights based on unstructured survey response data in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer readable medium can comprise instructions that, when executed by one or more processors, cause a computing device to perform the acts of FIG. 6. In still further embodiments a system can perform the acts of FIG. 6.

The series of acts 600 includes an act 602 of identifying indicators of impact factors from unstructured survey responses. For example, act 602 involves identifying, from unstructured responses to an electronic survey question, indicators of a set of impact factors corresponding to an entity associated with the electronic survey question. Act 602 can involve identifying an unstructured response of the unstructured responses comprising a textual response to the electronic survey question. Act 602 can then involve determining that the textual response comprises a word or a phrase indicating at least one impact factor of the set of impact factors. Act 602 can also involve determining that a threshold number of the unstructured responses comprise an indication of at least one impact factor of the set of impact factors.

Additionally, the series of acts 600 includes an act 604 of generating impact-factor scores for an entity. For example, act 604 involves generating a set of impact-factor scores for the set of impact factors corresponding to the entity, the set of impact-factor scores representing relationships between the set of impact factors and a target for the entity. Act 604 can involve determining, for an impact factor of the set of impact factors, a causal correlation between the impact factor and the target based on an R-squared coefficient for the impact factor and the target. Alternatively, act 604 can involve determining, for each impact factor of the set of impact factors, a relative weight that controls for other impact factors of the set of impact factors, and setting the impact-factor scores for the set of impact factors based on the relative weights of the set of impact factors.

Act 604 can further involve receiving, from the client device, an indication of a selection of the interactive impact-factor indicator. Act 604 can involve, based on the selection of the interactive impact-factor indicator, tracking, for a period of time, an impact of the impact factor associated with the interactive impact-factor indicator relative to other impact factors of the set of impact factors. Additionally, act 604 can involve based on the impact of the impact factor relative to the other impact factors, updating an impact-factor score for the impact factor associated with the interactive impact-factor indicator.

The series of acts 600 also includes an act 606 of determining impact-factor rankings for the impact factors. For example, act 606 involves determining impact-factor rankings for the set of impact factors based on the set of impact-factor scores and a relative performance of the entity for the set of impact factors. Act 606 can involve generating a relative-performance score for the entity representing a comparison between a relative performance of the entity for an impact factor of the set of impact factors and relative performances of additional entities for the impact factor. Additionally, act 606 can then involve ranking the set of impact factors based in part on a combination of the impact-factor score for the impact factor corresponding to the entity and the relative-performance score for the entity.

The series of acts 600 further includes an act 608 of providing an interactive impact-factor indicator for a suggested impact factor. For example, act 608 involves providing for display on a client device, an interactive impact-factor indicator representing a suggested impact factor from among the set of impact factors based on the impact-factor rankings.

As part of act 608, or as an additional act, the series of acts 600 can include receiving, from the client device, an indication of a selection of a filter parameter. The series of acts 600 can include, based on the selection of the filter parameter, filter the set of impact factors according to a numeric or categorical characteristic of unstructured responses corresponding to one or more impact factors from the set of impact factors. Additionally, the series of acts 600 can include providing, for display on the client device, a plurality of interactive impact-factor indicators corresponding to the filtered set of impact factors.

The series of acts 600 can also include determining one or more available actions for improving the relative performance of the entity for the suggested impact factor. The series of acts 600 can then include providing, for display on the client device, a recommended action of the one or more available actions. Additionally, the series of acts 600 can include generating an action plan comprising the recommended action.

Additionally, the series of acts 600 can include ranking the set of impact factors based on a plurality of electronic survey questions. For example, the series of acts 600 can include identifying, from additional unstructured responses to a plurality of electronic survey questions, indicators of additional impact factors corresponding to the entity, wherein the plurality of electronic survey questions are associated with the entity. The series of acts 600 can then include generating additional impact-factor scores for the additional impact factors. The series of acts 600 can include determining rankings for the additional impact factors in connection with the rankings for the set of impact factors and a relative performance of the entity for the additional impact factors. The series of acts 600 can then include providing the interactive impact-factor indicator representing the suggested impact factor based on the rankings of the set of impact factors and the rankings for the additional impact factors.

Embodiments of the present disclosure may comprise or utilize a special-purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

FIG. 7 illustrates a block diagram of an exemplary computing device 700 that may be configured to perform one or more of the processes described above. One will appreciate that one or more computing devices such as the computing device 700 may implement the devices described above in connection with FIG. 1. As shown by FIG. 7, the computing device 700 can comprise a processor 702, a memory 704, a storage device 706, an I/O interface 708, and a communication interface 710, which may be communicatively coupled by way of a communication infrastructure 712. While the exemplary computing device 700 is shown in FIG. 7, the components illustrated in FIG. 7 are not intended to be limiting. Additional or alternative components may be used in other embodiments. Furthermore, in certain embodiments, the computing device 700 can include fewer components than those shown in FIG. 7. Components of the computing device 700 shown in FIG. 7 will now be described in additional detail.

In one or more embodiments, the processor 702 includes hardware for executing instructions, such as those making up a computer program. As an example, and not by way of limitation, to execute instructions, the processor 702 may retrieve (or fetch) the instructions from an internal register, an internal cache, the memory 704, or the storage device 706 and decode and execute them. In one or more embodiments, the processor 702 may include one or more internal caches for data, instructions, or addresses. As an example, and not by way of limitation, the processor 702 may include one or more instruction caches, one or more data caches, and one or more translation lookaside buffers (“TLBs”). Instructions in the instruction caches may be copies of instructions in the memory 704 or the storage device 706.

The memory 704 may be used for storing data, metadata, and programs for execution by the processor(s). The memory 704 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 704 may be internal or distributed memory.

The storage device 706 includes storage for storing data or instructions. As an example, and not by way of limitation, storage device 706 can comprise a non-transitory storage medium described above. The storage device 706 may include a hard disk drive (“HDD”), a floppy disk drive, flash memory, an optical disc, a magneto-optical disc, magnetic tape, or a Universal Serial Bus (“USB”) drive or a combination of two or more of these. The storage device 706 may include removable or non-removable (or fixed) media, where appropriate. The storage device 706 may be internal or external to the computing device 700. In one or more embodiments, the storage device 706 is non-volatile, solid-state memory. In other embodiments, the storage device 706 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 708 allows a user to provide input to, receive output from, and otherwise transfer data to and receive data from the computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (“NIC”) or network adapter for communicating with an Ethernet or other wire-based network or a wireless NIC (“WNIC”) or wireless adapter for communicating with a wireless network, such as a WI-FI.

Additionally, or alternatively, the communication interface 710 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 710 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MIMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 712 may include hardware, software, or both that couples components of the computing device 700 to each other. As an example and not by way of limitation, the communication infrastructure 712 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

FIG. 8 illustrates an example network environment 800 of the digital survey system 104. Network environment 800 includes a client device 806, and a server device 802 connected to each other by a network 804. Although FIG. 8 illustrates a particular arrangement of client device 806, server device 802, and network 804, this disclosure contemplates any suitable arrangement of client device 806, server device 802, and network 804. As an example, and not by way of limitation, two or more of the client devices 806, and server devices 802 may be connected to each other directly, bypassing network 804. As another example, two or more of client devices 806 and server devices 802 may be physically or logically co-located with each other in whole, or in part. Moreover, although FIG. 8 illustrates a particular number of client devices 806, server devices 802, and networks 804, this disclosure contemplates any suitable number of client devices 806, server devices 802, and networks 804. As an example, and not by way of limitation, network environment 800 may include multiple client devices 806, server devices 802, and networks 804.

This disclosure contemplates any suitable network 804. As an example and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, and server device 802 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”)), wireless (such as for example Wi-Fi or Worldwide Interoperability for Microwave Access (“WiMAX”)), or optical (such as for example Synchronous Optical Network (SONET) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at client device 806 to access network 804.

In particular embodiments, client device 806 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at client device 806 may enter a Uniform Resource Locator (“URL”) or other address directing the web browser to a particular server (such as server, or a server associated with a third-party system), and the web browser may generate a Hyper Text Transfer Protocol (“HTTP”) request and communicate the HTTP request to server. The server may accept the HTTP request and communicate to client device 806 one or more Hyper Text Markup Language (“HTML”) files responsive to the HTTP request. Client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, server device 802 may include a variety of servers, sub-systems, programs, modules, logs, and data stores. In particular embodiments, server device 802 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Server device 802 may also include suitable components such as network interfaces, security mechanisms, load balancers, failover servers, management-and-network-operations consoles, other suitable components, or any suitable combination thereof.

In particular embodiments, server device 802 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users (e.g., users 116a and 116n, customers, etc.).

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A system comprising:
at least one processor; and
at least one non-transitory computer readable storage medium storing instructions that, when executed by the at least one processor, cause the system to:
identify, from unstructured responses to an electronic survey question, indicators of a set of impact factors corresponding to an entity associated with the electronic survey question;
generate a set of impact-factor scores for the set of impact factors corresponding to the entity, the set of impact-factor scores representing relationships between the set of impact factors and a target for the entity;
determine impact-factor rankings for the set of impact factors based on the set of impact-factor scores and a relative performance of the entity for the set of impact factors; and
provide, for display on a client device, an interactive impact-factor indicator representing a suggested impact factor from among the set of impact factors based on the impact-factor rankings.

2. The system as recited in claim 1, further comprising instructions that, when executed by the at least one processor, cause the system to generate the set of impact-factor scores for the set of impact factors by determining, for an impact factor of the set of impact factors, a causal correlation between the impact factor and the target based on an R-squared coefficient for the impact factor and the target.

3. The system as recited in claim 1, further comprising instructions that, when executed by the at least one processor, cause the system to generate the set of impact-factor scores for the set of impact factors by:
determining, for each impact factor of the set of impact factors, a relative weight that controls for other impact factors of the set of impact factors; and
generating the impact-factor scores for the set of impact factors based on the relative weights of the set of impact factors.

4. The system as recited in claim 1, further comprising instructions that, when executed by the at least one processor, cause the system to identify the indicators of the set of impact factors by:
identifying an unstructured response of the unstructured responses comprising a textual response to the electronic survey question; and
determining that the textual response comprises a word or a phrase indicating at least one impact factor of the set of impact factors.

5. The system as recited in claim 1, further comprising instructions that, when executed by the at least one processor, cause the system to determine the impact-factor rankings by:
generating a relative-performance score for the entity representing a comparison between a relative performance of the entity for an impact factor of the set of impact factors and relative performances of additional entities for the impact factor; and
ranking the set of impact factors based in part on a combination of the impact-factor score for the impact factor corresponding to the entity and the relative-performance score for the entity.

6. The system as recited in claim 1, further comprising instructions that, when executed by the at least one processor, cause the system to:
receive, from the client device, an indication of a selection of a filter parameter;
based on the selection of the filter parameter, filter the set of impact factors according to a numeric or categorical characteristic of unstructured responses corresponding to one or more impact factors from the set of impact factors; and
provide, for display on the client device, a plurality of interactive impact-factor indicators corresponding to the filtered set of impact factors.

7. The system as recited in claim 1, further comprising instructions that, when executed by the at least one processor, cause the system to generate the set of impact-factor scores for the set of impact factors by:
receiving, from the client device, an indication of a selection of the interactive impact-factor indicator;
based on the selection of the interactive impact-factor indicator, tracking, for a period of time, an impact of the impact factor associated with the interactive impact-factor indicator relative to other impact factors of the set of impact factors; and
based on the impact of the impact factor relative to the other impact factors, updating an impact-factor score for the impact factor associated with the interactive impact-factor indicator.

8. The system as recited in claim 1, further comprising instructions that, when executed by the at least one processor, cause the system to:
determine one or more available actions for improving the relative performance of the entity for the suggested impact factor; and
provide, for display on the client device, a recommended action of the one or more available actions.

9. A non-transitory computer readable storage medium storing instructions that, when executed by at least one processor, cause a computing device to:
identify, from unstructured responses to an electronic survey question, indicators of a set of impact factors corresponding to an entity associated with the electronic survey question;
generate a set of impact-factor scores for the set of impact factors corresponding to the entity, the set of impact-factor scores representing relationships between the set of impact factors and a target for the entity;
determine impact-factor rankings for the set of impact factors based on the set of impact-factor scores and a relative performance of the entity for the set of impact factors; and
provide, for display on a client device, an interactive impact-factor indicator representing a suggested impact factor from among the set of impact factors based on the impact-factor rankings.

10. The non-transitory computer readable storage medium as recited in claim 9, further comprising instructions that, when executed by the at least one processor, cause the computing device to generate the set of impact-factor scores for the set of impact factors by determining, for an impact factor of the set of impact factors, a causal correlation between the impact factor and the target based on an R-squared coefficient for the impact factor and the target.

11. The non-transitory computer readable storage medium as recited in claim 9, further comprising instructions that, when executed by the at least one processor, cause the computing device to generate the set of impact-factor scores for the set of impact factors by:
determining, for each impact factor of the set of impact factors, a relative weight that controls for other impact factors of the set of impact factors; and
generating the impact-factor scores for the set of impact factors based on the relative weights of the set of impact factors.

12. The non-transitory computer readable storage medium as recited in claim 9, further comprising instructions that, when executed by the at least one processor, cause the computing device to identify the indicators of the set of impact factors by determining that a threshold number of the unstructured responses comprise an indication of at least one impact factor of the set of impact factors.

13. The non-transitory computer readable storage medium as recited in claim 9, further comprising instructions that, when executed by the at least one processor, cause the computing device to:
based on a selection from the client device, filter the set of impact factors according to an emotional characteristic of unstructured responses corresponding to one or more impact factors from the set of impact factors; and
provide, for display on the client device, a plurality of interactive impact-factor indicators corresponding to the filtered set of impact factors.

14. The non-transitory computer readable storage medium as recited in claim 9, further comprising instructions that, when executed by the at least one processor, cause the computing device to determine the rankings for the set of impact factors by determining a relative performance of the entity for an impact factor from the set of impact factors relative to relative performances of a set of peers of the entity or relative to a maximum performance metric.

15. The non-transitory computer readable storage medium as recited in claim 9, further comprising instructions that, when executed by the at least one processor, cause the computing device to:
identify, from additional unstructured responses to a plurality of electronic survey questions, indicators of additional impact factors corresponding to the entity, wherein the plurality of electronic survey questions are associated with the entity;
generate additional impact-factor scores for the additional impact factors;
determine rankings for the additional impact factors in connection with the rankings for the set of impact factors and a relative performance of the entity for the additional impact factors; and
provide the interactive impact-factor indicator representing the suggested impact factor based on the rankings of the set of impact factors and the rankings for the additional impact factors.

16. A computer-implemented method comprising:
identifying, by at least one processor and from unstructured responses to an electronic survey question, indicators of a set of impact factors corresponding to an entity associated with the electronic survey question;
generating, by the at least one processor, a set of impact-factor scores for the set of impact factors corresponding to the entity, the set of impact-factor scores representing relationships between the set of impact factors and a target for the entity;
determining, by the at least one processor, impact-factor rankings for the set of impact factors based on the set of impact-factor scores and a relative performance of the entity for the set of impact factors; and
providing, for display on a client device, an interactive impact-factor indicator representing a suggested impact factor from among the set of impact factors based on the impact-factor rankings.

17. The computer-implemented method as recited in claim 16, wherein generating the set of impact-factor scores for the set of impact factors comprises determining, for an impact factor of the set of impact factors, a causal correlation between the impact factor and the target based on an R-squared coefficient for the impact factor and the target.

18. The computer-implemented method as recited in claim 16, wherein generating the set of impact-factor scores for the set of impact factors comprises:
determining, for each impact factor of the set of impact factors, a relative weight that controls for other impact factors of the set of impact factors; and
generating the impact-factor scores for the set of impact factors based on the relative weights of the set of impact factors.

19. The computer-implemented method as recited in claim 16, wherein identifying the indicators of the set of impact factors comprises:
identifying an unstructured response of the unstructured responses comprising a textual response to the electronic survey question; and
determining that the textual response that comprises a word or a phrase indicating at least one impact factor of the set of impact factors.

20. The computer-implemented method as recited in claim 16, further comprising:
determining available actions for improving a relative performance of the entity for the suggested impact factor;
providing, for display on the client device, one or more recommended actions of the available actions; and
generating an action plan comprising at least one action of the one or more recommended actions.
